(19) United States
(12) Patent Application Publication
(10) Pub. No.: US 2024/0372408 A1
(43) Pub. Date: Nov. 7, 2024

(54) POWER RECEIVING DEVICE, CONTROL METHOD FOR POWER RECEIVING DEVICE, AND STORAGE MEDIUM

(71) Applicant: CANON KABUSHIKI KAISHA, Tokyo (JP)

(72) Inventor: RYUTA MIZUMORI, Kanagawa (JP)

(21) Appl. No.: 18/742,541

(22) Filed: Jun. 13, 2024

Related U.S. Application Data
(63) Continuation of application No. PCT/JP2022/043290, filed on Nov. 24, 2022.

(30) Foreign Application Priority Data
Dec. 14, 2021 (JP) 2021-202431

(51) Int. Cl. H02J 50/60; H02J 50/12; H02J 50/80

(52) U.S. Cl. CPC H02J 50/60; H02J 50/12; H02J 50/80

(57) ABSTRACT

Information about a transmission power control minimum period for performing foreign object detection using a waveform decay method is obtained from a power transmission device. The obtained transmission power control minimum period is compared with a transmission power control maximum period allowed for a power receiving device. In a case where the transmission power control minimum period that can be generated by the power transmission device is longer than the transmission power control maximum period allowed for the power receiving device, a flag indicating not to implement foreign object detection using the waveform decay method is set, and the fact that the transmission power control maximum period is set to zero is sent to the power transmission device.

### CROSS-REFERENCE TO RELATED APPLICATIONS

This application is a Continuation of International Patent Application No. PCT/JP2022/043290, filed Nov. 24, 2022, which claims the benefit of Japanese Patent Application No. 2021-202431, filed Dec. 14, 2021, both of which are hereby incorporated by reference herein in their entireties.

### TECHNICAL FIELD

The present disclosure particularly relates to a power receiving device configured to receive power wirelessly, a control method for the power receiving device, and a storage medium.

### BACKGROUND ART

In recent years, the technical development of wireless power transmission systems has been widely performed. In a wireless power transmission system, when there is an object (hereinafter referred to as a foreign object) different from a power receiving device and a power transmission device within a range where the power transmission device can transmit power, it is essential to detect the foreign object and control the transmission and reception of power. Patent Literature 1 discloses a method of, in the case where there is a foreign object in the vicinity of a power transmitting/receiving device compliant with the WPC (Wireless Power Consortium) standards, detecting the foreign object and restricting transmission and reception of power.

Furthermore, while a foreign object detection method is specified in the WPC standards, alternative foreign object detection methods that are not specified in the WPC standards have also been proposed. Patent Literature 2 discloses a foreign object detection method of detecting the presence of an object based on a change in energy attenuation or a change in resonant frequency of a power transmission coil and a resonant circuit integrated or coupled with the power transmission coil. In this method, a power transmission device is configured to send a signal for foreign object detection to a power receiving device, and determine the presence or absence of a foreign object using an echo signal from the power receiving device.

### CITATION LIST

### Patent Literature

PTL 1 Japanese Patent Laid-Open No. 2017-70074
PTL 2 Japanese Patent Laid-Open No. 2015-27172

In the case of applying a foreign object detection method using a change in attenuation of the energy waveform as disclosed in Patent Literature 2 to the WPC standards, it is required that issues due to waveform attenuation do not occur in either the power transmission device or the power receiving device. In addition, since each process in the WPC standards is managed by the power receiving device, it has not been specified what kind of control would be performed on the power receiving device side when the situation becomes unsuitable for foreign object detection.

### SUMMARY

In view of the foregoing issues, it is an object of the present disclosure to perform appropriate control in foreign object detection based on waveform attenuation when the situation becomes unsuitable for foreign object detection.

A power receiving device according to the present disclosure receives power wirelessly from a power transmission device and obtain information on a first period in which the power transmission device limits power transfer.

Further features of the present disclosure will become apparent from the following description of exemplary embodiments with reference to the attached drawings.

### BRIEF DESCRIPTION OF DRAWINGS

FIG. 1 is a block diagram illustrating an example of the internal configuration of a power transmission device according to an embodiment.

FIG. 2 is a block diagram illustrating an example of the internal configuration of a power receiving device according to the embodiment.

FIG. 3 is a block diagram illustrating an example of the functional configuration of a control unit of the power transmission device.

FIG. 4 is a diagram illustrating an example of the configuration of a wireless power transmission system according to the embodiment.

FIG. 5 is a diagram for describing a sequence for power transmission according to the WPC standards.

FIG. 6 is a diagram for describing the principle of foreign object detection using a waveform decay method.

FIG. 7 is a diagram for describing each period when performing foreign object detection using the waveform decay method.

FIG. 8 is a diagram for describing a foreign object detection method using a power loss method.

FIG. 9 is a diagram for describing a waveform attenuation rate according to transmitted power.

FIG. 10A is a flowchart illustrating an example of the processing procedure performed by the power receiving device to perform foreign object detection using the waveform decay method according to a first embodiment.

FIG. 10B is a flowchart illustrating an example of the processing procedure performed by the power receiving device to perform foreign object detection using the waveform decay method according to the first embodiment.

FIG. 11A is a flowchart illustrating an example of the processing procedure performed by the power transmission device to perform foreign object detection using the waveform decay method according to the first embodiment.

FIG. 11B is a flowchart illustrating an example of the processing procedure performed by the power transmission device to perform foreign object detection using the waveform decay method according to the first embodiment.

FIG. 12 is a flowchart illustrating an example of the processing procedure performed by the power receiving device to perform foreign object detection using the waveform decay method according to a second embodiment.

FIG. 13 is a flowchart illustrating an example of the processing procedure performed by the power transmission device to perform foreign object detection using the waveform decay method according to the second embodiment.

### DESCRIPTION OF EMBODIMENTS

### First Embodiment

Hereinafter, embodiments will now described in detail with reference to the accompanying drawings. Although the embodiments describe multiple features, not all of these multiple features are essential to the present disclosure, and the multiple features may be combined in any manner. Furthermore, identical or similar configurations are given the same reference numerals in the accompanying drawings.

### Configuration of Wireless Power Transmission System

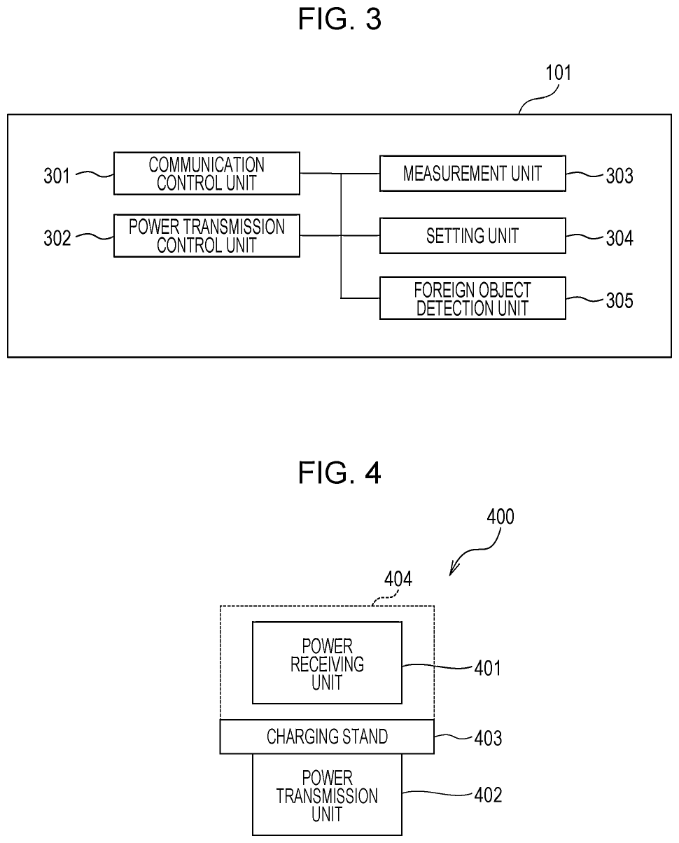

FIG. 4 is a diagram illustrating an example of the configuration of a wireless power transmission system (wireless charging system) 400 according to an embodiment. This system is configured including, in one example, a power receiving device 401 and a power transmission device 402. Note that the detailed configuration of the power receiving device 401 and the power transmission device 402 will be described later.

The power receiving device 401 is an electronic device configured to receive power from the power transmission device 402 and charge its built-in battery. The power transmission device 402 is an electronic device configured to wirelessly transmit power to the power receiving device 401, which is placed thereon with a charging stand 403 interposed therebetween. Hereinafter, being placed on the charging stand 403 is simply expressed as being placed on the power transmission device 402. A range 404 enclosed by a dotted line is a range within which the power receiving device 401 can receive power from the power transmission device 402. Note that the power receiving device 401 and the power transmission device 402 have functions for executing applications other than wireless charging. Also, in the following description, objects that are different from the power transmission device 402 and the power receiving device 401 and that are included in the range within which the power transmission device 402 can transmit power will be referred to as foreign objects.

Note that, in the following description, it is assumed that “the power receiving device 401 is placed on the power transmission device 402” represents “a state in which the power receiving device 401 is included in the power transmittable range of the power transmission device 402.” The power transmittable range of the power transmission device 402 is the range within which power can be transmitted to the power receiving device 401 using a power transmission coil. Also, in a state in which the power receiving device 401 is placed on the power transmission device 402, the power receiving device 401 and the power transmission device 402 need not be in contact with each other. For example, a state in which the power receiving device 401 is included in the power transmittable range without being in contact with the power transmission device 402 is also considered to be “a state in which the power receiving device 401 is placed on the power transmission device 402.” The power receiving device 401 may also be configured to be disposed, for example, on the side of the power transmission device 402, rather than being placed on top of the power transmission device 402.

Note that the power receiving device 401 and the power transmission device 402 may have functions for executing applications other than wireless charging. An example of the power receiving device 401 is an information processing terminal such as a smartphone, and an example of the power transmission device 402 is an accessory device for charging the information processing terminal. For example, the information terminal device has a display configured to display information to the user, to which power received from a power receiving coil (antenna) is supplied. In addition, the power received from the power receiving coil is stored in a power storage unit (battery), and the power is supplied from the battery to the display. In this case, the power receiving device 401 may have a communication unit configured to communicate with other devices different from the power transmission device 402. It is acceptable for the communication unit to support communication standards such as the near-field communication (NFC) and fifth generation mobile communication system (5G). In this case, the communication unit may also perform communication by being supplied with power from the battery. Moreover, the power receiving device 401 may be a tablet terminal, a storage device such as a hard disk drive (HDD) and a memory device, or an information processing device such as a personal computer (PC). In addition, the power receiving device 401 may be, for example, an imaging device (camera, video camera, etc.). The power receiving device 401 may also be an image input device such as a scanner, or an image output device such as a printer, copier, projector, etc. The power receiving device 401 may also be a robot, a medical device, or the like. It is permissible for the power transmission device 402 to be a device for charging the aforementioned equipment.

Furthermore, the power transmission device 402 may be a smartphone. In this case, the power receiving device 401 may be another smartphone or may be a wireless earphone.

In addition, the power receiving device 401 in the present embodiment may be a vehicle such as an automobile. For example, an automobile which serves as the power receiving device 401 may be configured to receive power from a charger (power transmission device 402) via a power transmission antenna installed in a parking lot. An automobile which serves as the power receiving device 401 may also be configured to receive power from a charger (power transmission device 402) via a power transmission coil (antenna) embedded in the road. In such an automobile, the received power is supplied to a battery. The power of the battery may be supplied to actuators (motors, electric units) configured to drive the wheels, or may be used to drive sensors used for drive assistance or to drive a communication unit configured to communicate with external devices. That is, in this case, the power receiving device 401 may have, in addition to wheels, the battery, motors, and sensors driven by the received power, as well as the communication unit configured to communicate with devices other than the power transmission device 402. Furthermore, the power receiving device 401 may have a housing to accommodate a person. The sensors include, for example, sensors used to measure the distance between vehicles or with other obstacles. The communication unit may support, for example, a global positioning system (or global positioning satellite (GPS)). It is acceptable for the communication unit to support a communication standard such as 5G. Additionally, vehicles may include bicycles and motorcycles. In addition, the power receiving device 401 is not limited to a vehicle and may also be a moving or flying object equipped with an actuator driven using power stored in a battery.

In addition, the power receiving device 401 in the present embodiment may be an electric tool, a household appliance, or the like. These devices which serve as the power receiving device 401 may also have a motor driven by received power stored in a battery, in addition to the battery itself. These devices may also have a notification unit configured to report the remaining amount of the battery, and the like. These devices may also have a communication unit configured to communicate with other devices different from the power transmission device 402. It is acceptable for the communication unit to support communication standards such as NFC and 5G.

In addition, the power transmission device 402 in the present embodiment may be a vehicle-mounted charger configured to transmit power to a mobile information terminal device such as a smartphone or a tablet supporting wireless power transmission, inside the vehicle which may be an automobile. The vehicle-mounted charger as above may be provided anywhere inside the automobile. For example, the vehicle-mounted charger may be installed on the console of the automobile, on the instrument panel (dashboard), between passenger seats, on the ceiling, or on the doors. However, it is preferable not to install the vehicle-mounted charger in locations that may obstruct driving. Also, although the power transmission device 402 has been described as an example of a vehicle-mounted charger, such chargers are not limited to being installed in vehicles and may also be installed in transport vehicles such as trains, airplanes, and ships. In this case, the chargers may be installed between passenger seats, on the ceiling, or on the doors.

In addition, a vehicle such as an automobile equipped with a vehicle-mounted charger may also serve as the power transmission device 402. In this case, the power transmission device 402 has wheels and a battery, and uses the power of the battery to supply power to the power receiving device 401 through a power transmission circuit unit and a power transmission coil (antenna).

### Configuration of Power Transmission Device 402 and Power Receiving Device 401

The configuration of the power transmission device 402 and the power receiving device 401 in the present embodiment will now be described. Note that the configuration described below is merely an example, and part (and possibly all) of the configuration described may be omitted or replaced with other configuration serving other similar functions, and further configuration may be added to the configuration described. Furthermore, one block discussed in the following description may be divided into multiple blocks, or multiple blocks may be integrated into one block. In addition, although it is assumed that each functional block discussed below has its functionality implemented as a software program, some or all of the functionality contained in this functional block may be implemented as hardware.

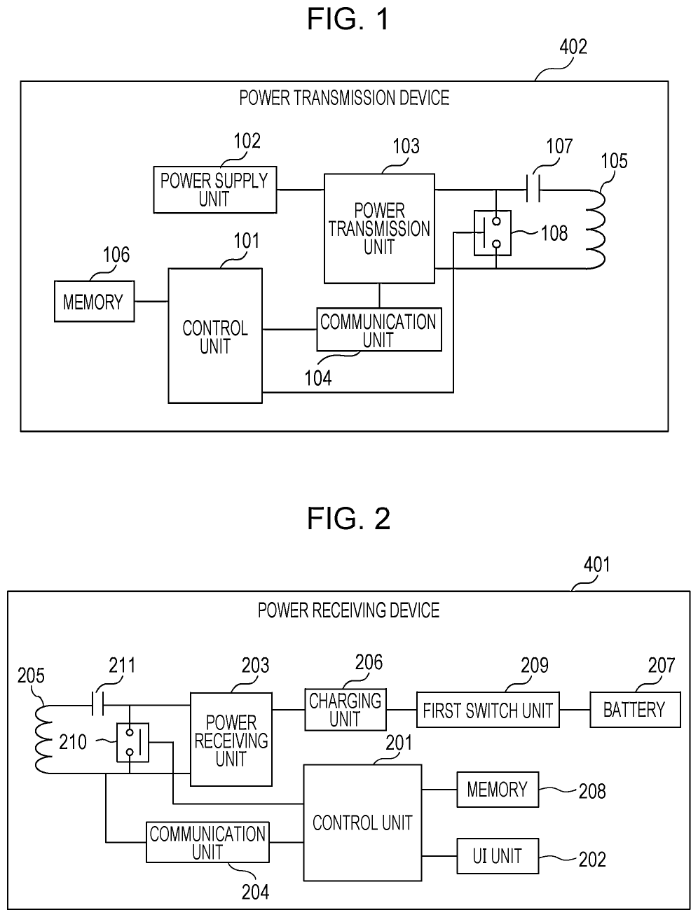

FIG. 1 is a block diagram illustrating an example of the internal configuration of the power transmission device 402 according to the present embodiment. FIG. 2 is a block diagram illustrating an example of the internal configuration of the power receiving device 401 according to the present embodiment. The power transmission device 402 has a control unit 101, a power supply unit 102, a power transmission unit 103, a communication unit 104, a power transmission antenna 105, a memory 106, a resonant capacitor 107, and a switch 108. Although the control unit 101, the power supply unit 102, the power transmission unit 103, the communication unit 104, and the memory 106 are depicted as separate units in FIG. 1, any plurality of functional blocks thereof may be implemented in the same chip.

The control unit 101 controls the entire power transmission device 402 by executing a control program stored in the memory 106, for example. The control unit 101 also performs control related to power transmission control including communication for device authentication of the power transmission device 402. The control unit 101 may further perform control for executing applications other than wireless power transmission. The control unit 101 is configured including one or more processors, such as a central processing unit (CPU) or a microprocessor unit (MPU). Note that the control unit 101 may be configured with hardware such as an application-specific integrated circuit (ASIC). The control unit 101 may also be configured including an array circuit such as a field programmable gate array (FPGA) compiled to execute certain processing. The control unit 101 causes the memory 106 to store information to be stored during the execution of various processes. The control unit 101 also measures the time using a timer (not illustrated).

The power supply unit 102 supplies power to each functional block. The power supply unit 102 is, for example, a commercial power source or a battery. The battery stores power supplied from a commercial power source.

The power transmission unit 103 converts direct current (DC) or alternating current (AC) power input from the power supply unit 102 into AC frequency power in a frequency band used for wireless power transmission, and outputs the AC frequency power to the power transmission antenna 105, thereby generating electromagnetic waves for allowing the power receiving device 401 to receive power. For example, the power transmission unit 103 converts DC voltage supplied by the power supply unit 102 into AC voltage through a switching circuit of a half-bridge or full-bridge configuration using field-effect transistors (FETs). In this case, the power transmission unit 103 includes a gate driver that controls the ON/OFF states of the FETs.

The power transmission unit 103 also controls the magnitude of electromagnetic waves to be output by adjusting the voltage (transmission power voltage) or current (transmission power current), or both, output to the power transmission antenna 105. Increasing the transmission power voltage or transmission power current results in higher magnitude of the electromagnetic waves, and decreasing the transmission power voltage or transmission power current results in lower magnitude of the electromagnetic waves. The power transmission unit 103 performs output control of AC frequency power, based on instructions from the control unit 101, to start or stop power transmission from the power transmission antenna 105. Moreover, it is assumed that the power transmission unit 103 has the capability to supply power sufficient to output 15 watts (W) of power to a charging unit 206 of the power receiving device 401 supporting the WPC standards.

The communication unit 104 communicates with the power receiving device 401 for power transmission control based on the WPC standards. The communication unit 104 performs frequency shift keying (FSK) modulation of the electromagnetic waves output from the power transmission antenna 105, and transmits information to the power receiving device 401 to perform communication. The communication unit 104 also demodulates the electromagnetic waves transmitted from the power transmission antenna 105, which have been amplitude-modulated or load-modulated by the power receiving device 401, to retrieve information transmitted by the power receiving device 401. That is, communication performed by the communication unit 104 is performed by superimposing signals on the electromagnetic waves transmitted from the power transmission antenna 105. It is also acceptable for the communication unit 104 to communicate with the power receiving device 401 based on standards different from the WPC standards, using an antenna different from the power transmission antenna 105, or to communicate with the power receiving device 401 using multiple types of communications in a selective manner. Examples of the communication standards include Bluetooth® Low Energy (BLE), NFC, and the like.

In addition to storing control programs, the memory 106 also stores the state (transmitted power value, received power value, etc.) of the power transmission device 402 and the power receiving device 401. For example, the state of the power transmission device 402 is obtained by the control unit 101, and the state of the power receiving device 401 is obtained by a control unit 201 of the power receiving device 401 and received via the communication unit 104.

The switch 108 is controlled by the control unit 101. The power transmission antenna 105 is connected to the resonant capacitor 107, and, in the case where the switch 108 is turned ON and short-circuited, the power transmission antenna 105 and the resonant capacitor 107 form a series resonant circuit, resonating at a specific frequency f1. At this time, current flows through a closed circuit formed of the power transmission antenna 105, the resonant capacitor 107, and the switch 108. When the switch 108 is turned OFF and becomes open, power is supplied from the power transmission unit 103 to the power transmission antenna 105 and the resonant capacitor 107.

Next, an example of the internal configuration of the power receiving device 401 according to the present embodiment will be described with reference to FIG. 2. The power receiving device 401 has the control unit 201, a user interface (UI) unit 202, a power receiving unit 203, a communication unit 204, a power receiving antenna 205, the charging unit 206, a battery 207, a memory 208, a first switch unit 209, a second switch unit 210, and a resonant capacitor 211. Note that multiple functional blocks illustrated in FIG. 2 may be realized as a single hardware module.

The control unit 201 controls the entire power receiving device 401 by executing a control program stored in the memory 208, for example. That is, the control unit 201 controls the functional units illustrated in FIG. 2. The control unit 201 may further perform control for executing applications other than wireless power transmission. An example of the control unit 201 is configured including one or more processors, such as CPUs or MPUs. Note that the entire power receiving device 401 may be controlled in cooperation with the operating system (OS) executed by the control unit 201.

Moreover, the control unit 201 may be configured with hardware such as an ASIC. The control unit 201 may also be configured including an array circuit such as an FPGA compiled to execute certain processing. The control unit 201 causes the memory 208 to store information to be stored during the execution of various processes. The control unit 201 also measures the time using a timer (not illustrated).

The UI unit 202 performs various types of outputs to the user. Various types of outputs mentioned here include operations such as screen displays, blinking and/or color changes of a light emitting diode (LED), audio outputs by a speaker, and vibrations of the power receiving device 401 itself. The UI unit 202 is realized by a liquid crystal panel, a speaker, a vibration motor, etc.

The power receiving unit 203 obtains, via the power receiving antenna 205, AC power (AC voltage and AC current) generated by electromagnetic induction based on electromagnetic waves emitted from the power transmission antenna 105 of the power transmission device 402. The power receiving unit 203 then converts the AC power into DC or AC power of a certain frequency, and outputs the power to the charging unit 206, which performs processing for charging the battery 207. That is, the power receiving unit 203 includes a rectifier unit and a voltage control unit, which are necessary for supplying power to a load in the power receiving device 401. It is assumed that the power receiving unit 203 has the capability to supply power allowing the charging unit 206 to charging the battery 207 and to supply power sufficient to output 15 watts of power to the charging unit 206.

The communication unit 204 communicates with the communication unit 104 included in the power transmission device 402 for power receiving control based on the WPC standards as mentioned earlier. The communication unit 204 demodulates the electromagnetic waves input from the power receiving antenna 205 to retrieve information transmitted from the power transmission device 402. Then, the communication unit 204 communicates with the power transmission device 402 by superimposing signals pertaining to information to be transmitted to the power transmission device 402 onto the electromagnetic waves through amplitude modulation or load modulation of the input electromagnetic waves. Note that the communication unit 204 may communicate with the power transmission device 402 based on standards different from the WPC standards, using an antenna different from the power receiving antenna 205, or to communicate with the power transmission device 402 using multiple types of communications in a selective manner. Examples of the communication standards include BLE and NFC as mentioned earlier.

In addition to storing control programs, the memory 208 also stores information pertaining to the state of the power transmission device 402 and the power receiving device 401. For example, information pertaining to the state of the power receiving device 401 is obtained by the control unit 201, and information pertaining to the state of the power transmission device 402 is obtained by the control unit 101 of the power transmission device 402 and received via the communication unit 204.

The first switch unit 209 and the second switch unit 210 are controlled by the control unit 201. The power receiving antenna 205 is connected to the resonant capacitor 211, and, in the case where the second switch unit 210 is turned ON and short-circuited, the power receiving antenna 205 and the resonant capacitor 211 form a series resonant circuit, resonating at a specific frequency f2. At this time, current flows through a closed circuit formed of the power receiving antenna 205, the resonant capacitor 211, and the second switch unit 210, whereas no current flows through the power receiving unit 203. When the second switch unit 210 is turned OFF and becomes open, power received by the power receiving antenna 205 and the resonant capacitor 211 is supplied to the power receiving unit 203.

The first switch unit 209 is for controlling whether to supply the received power to a battery, which is a load. The first switch unit 209 also has the function of controlling the value of the load. When the charging unit 206 and the battery 207 are connected by the first switch unit 209, the received power is supplied to the battery 207. When the first switch unit 209 disconnects the connection between the charging unit 206 and the battery 207, the received power is not supplied to the battery 207. Although the first switch unit 209 is disposed between the charging unit 206 and the battery 207 in FIG. 2, the first switch unit 209 may be disposed between the power receiving unit 203 and the charging unit 206. Alternatively, the first switch unit 209 may be disposed between a closed circuit formed of the power receiving antenna 205, the resonant capacitor 211, and the second switch unit 210, and the power receiving unit 203. That is, the first switch unit 209 may be for controlling whether to supply the received power to the power receiving unit 203. In addition, although the first switch unit 209 is depicted as a single block in FIG. 2, the first switch unit 209 may alternatively be realized as part of the charging unit 206 or part of the power receiving unit 203.

Next, the functions of the control unit 101 of the power transmission device 402 will be described with reference to FIG. 3. FIG. 3 is a block diagram illustrating an example of the functional configuration of the control unit 101 of the power transmission device 402. The control unit 101 has a communication control unit 301, a power transmission control unit 302, a measurement unit 303, a setting unit 304, and a foreign object detection unit 305.

The communication control unit 301 performs control communication with the power receiving device 401 based on the WPC standards via the communication unit 104. The power transmission control unit 302 controls the power transmission unit 103 and controls the transmission of power to the power receiving device 401. The measurement unit 303 measures a waveform attenuation index, which will be described later. In addition, the measurement unit 303 measures the power to be transmitted to the power receiving device 401 via the power transmission unit 103, and measures the average transmission power per unit time. The measurement unit 303 also measures the quality coefficient (Q-value) of the power transmission antenna (power transmission coil) 105.

The foreign object detection unit 305 realizes a foreign object detection function using the power loss method, a foreign object detection function using the Q-value measurement method, and a foreign object detection function using the waveform decay method. Note that the power loss method, the Q-value measurement method, and the waveform decay method will be described in detail later. It is also acceptable for the foreign object detection unit 305 to have a function for performing foreign object detection processing using other methods. For example, in the power transmission device 402 with the NFC communication function, the foreign object detection unit 305 may perform foreign object detection processing using an oncoming machine detection function based on the NFC standard. Moreover, the foreign object detection unit 305 can, as a function other than that for detecting foreign objects, detect changes in the state of the power transmission device 402. For example, the power transmission device 402 can also detect an increase or decrease in the number of power receiving devices 401 on the power transmission device 402.

The setting unit 304 sets a threshold that serves as a reference for the power transmission device 402 to determine the presence or absence of a foreign object in performing foreign object detection using the power loss method, the Q-value measurement method, and the waveform decay method. For example, the setting unit 304 sets a threshold used for foreign object detection based on the waveform attenuation index measured by the measurement unit 303. The setting unit 304 may also have a function of setting a threshold that serves as a reference for determining the presence or absence of a foreign object, which is necessary for performing foreign object detection processing using other methods. This allows the foreign object detection unit 305 to perform foreign object detection processing based on the threshold set by the setting unit 304 and the waveform attenuation index, transmission power, and Q-value measured by the measurement unit 303.

The functions of the communication control unit 301, the power transmission control unit 302, the measurement unit 303, the setting unit 304, and the foreign object detection unit 305 are realized as programs running on the control unit 101. These processing units are configured as independent programs, each capable of operating in parallel while maintaining synchronization between programs through event processing and the like. Note that two or more of the processing units may be incorporated into one program.

In this system, wireless power transmission using the electromagnetic induction method for wireless charging is performed based on the WPC standards. That is, the power receiving device 401 and the power transmission device 402 perform wireless power transmission for wireless charging based on the WPC standards between the power receiving antenna 205 of the power receiving device 401 and the power transmission antenna 105 of the power transmission device 402. Note that the wireless power transmission method applied to this system is not limited to the method specified in the WPC standards, and may include other methods such as another electromagnetic induction method, magnetic field resonance method, electric field resonance method, microwave method, method using laser, etc. Although it is assumed in the present embodiment that wireless power transmission is used for wireless charging, wireless power transmission may be performed for purposes other than wireless charging.

The WPC standards specify the magnitude of power guaranteed when the power receiving device 401 receives power from the power transmission device 402 by a value called guaranteed power (hereinafter referred to as “GP”). The GP indicates a power value at which output to a load (e.g., a circuit for charging, a battery, etc.) of the power receiving device 401 is guaranteed, for example, even if the positional relationship between the power receiving device 401 and the power transmission device 402 fluctuates and the power transmission efficiency between the power receiving antenna 205 and the power transmission antenna 105 decreases. For example, in the case where the GP is 5 watts, even if the positional relationship between the power receiving antenna 205 and the power transmission antenna 105 fluctuates and the power transmission efficiency decreases, the power transmission device 402 performs control to transmit power so that 5 watts of power can be output to the load in the power receiving device 401.

In addition, in the case of transmitting power from the power transmission device 402 to the power receiving device 401, if there is a foreign object as an object that is not the power receiving device 401 in the vicinity of the power transmission device 402, there is a risk that electromagnetic waves for power transmission may affect the foreign object to increase the temperature of the foreign object or destroy the foreign object. Accordingly, the WPC standards specify a method by which, in the presence of a foreign object, the power transmission device 402 detects the presence of the foreign object on the charging stand 403 so as to prevent an increase in temperature or destruction of the foreign object by stopping the power transmission. Specifically, the power loss method is specified for detecting a foreign object based on the difference between the transmitted power at the power transmission device 402 and the received power at the power receiving device 401. In addition, the WPC standards also specify, as a foreign object detection method, the Q-value measurement method for detecting a foreign object based on a change in the quality coefficient (Q-value) of the power transmission antenna (power transmission coil) 105 in the power transmission device 402. Note that a foreign object detected by the power transmission device 402 in the present embodiment is not limited to an object present on the charging stand 403. It is only necessary for the power transmission device 402 to detect a foreign object located in the vicinity of the power transmission device 402; for example, the power transmission device 402 may detect a foreign object located in a range within which the power transmission device 402 can transmit power.

### Foreign Object Detection Method Based on Power Loss Method

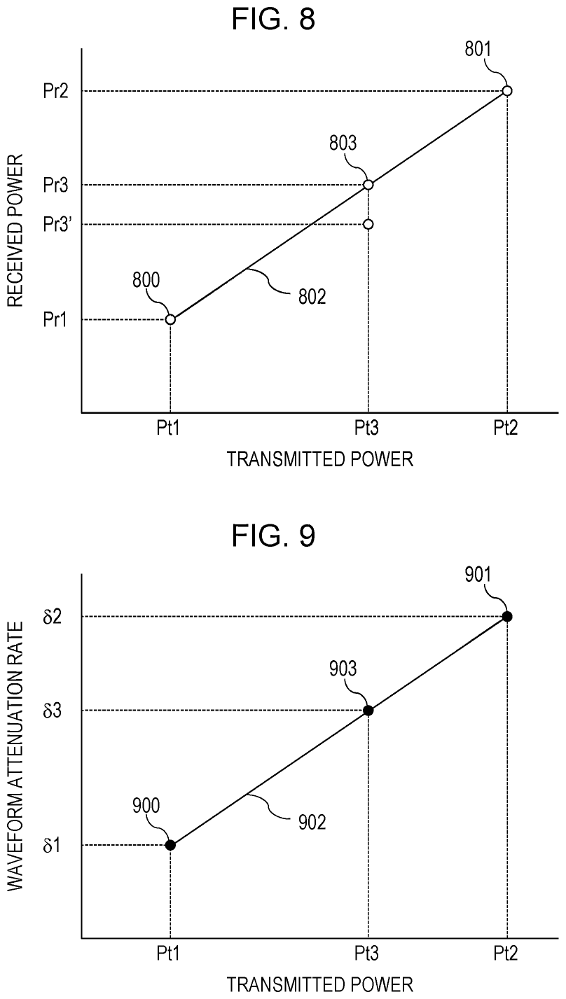

Next, the foreign object detection method based on the power loss method specified in the WPC standards will be described using FIG. 8. The horizontal axis in FIG. 8 represents the power transmitted by the power transmission device 402, whereas the vertical axis represents the power received by the power receiving device 401. Here, the term “foreign object” refers to an object other than the power receiving device 401, which may affect the transmission of power from the power transmission device 402 to the power receiving device 401, such as an object like a metal piece having electrical conductivity.

First, the power transmission device 402 transmits power to the power receiving device 401 at a first transmitted power value Pt1. The power receiving device 401 receives power at a first received power value Pr1 (this state is referred to as a state of light load (light load state)). The power transmission device 402 then stores the first transmitted power value Pt1. Here, the first transmitted power value Pt1 or the first received power value Pr1 is a predetermined minimum transmission power or received power, respectively. At this time, the power receiving device 401 controls the load (charging circuit, battery, etc.) so that the received power becomes the minimum power. For example, the power receiving device 401 may disconnect the load from the power receiving antenna 205 so that the received power will not be supplied to the load.

The power receiving device 401 then reports the first received power value Pr1 to the power transmission device 402. Having received information about the first received power value Pr1 from the power receiving device 401, the power transmission device 402 calculates a power loss amount Pt1−Pr1 (Pₗₒₛₛ1) between the power transmission device 402 and the power receiving device 401. Then, a calibration point 800 indicating the correspondence between the first transmitted power value Pt1 and the first received power value Pr1 is created.

Then, the power transmission device 402 changes the transmitted power value to a second transmitted power value Pt2 and transmits power to the power receiving device 401. The power receiving device 401 receives power at a second received power value Pr2 (this state is referred to as a state of connected load (load-connected state)). The power transmission device 402 then stores the second transmitted power value Pt2. Here, the second transmitted power value Pt2 or the second received power value Pr2 is a predetermined maximum transmitted power or received power. At this time, the power receiving device 401 controls the load so that the received power becomes the maximum power. For example, the power receiving device 401 connects the load to the power receiving antenna 205 so that the received power will be supplied to the load.

Then, the power receiving device 401 reports the second received power value Pr2 to the power transmission device 402. Having received information about the second received power value Pr2 from the power receiving device 401, the power transmission device 402 calculates a power loss amount Pt2−Pr2 (Pₗₒₛₛ2) between the power transmission device 402 and the power receiving device 401. Then, a calibration point 801 indicating the correspondence between the second transmitted power value Pt2 and the second received power value Pr2 is created.

The power transmission device 402 then creates a straight line 802, which linearly interpolates between the calibration point 800 and the calibration point 801. The straight line 802 depicts the relationship between the transmitted power and the received power in a state where there is no foreign object in the vicinity of the power transmission device 402 and the power receiving device 401. Based on the straight line 802, the power transmission device 402 can predict the power value of power received by the power receiving device 401 when power is transmitted at a certain transmitted power in a state with no foreign object. For example, in the case where the power transmission device 402 transmits power at a third transmitted power value Pt3, it can be inferred from a point 803 corresponding to Pt3 on the straight line 802 that a third received power value of power received by the power receiving device 401 will be Pr3.

As mentioned earlier, the power loss between the power transmission device 402 and the power receiving device 401 according to the load can be determined based on multiple combinations of the transmitted power value of the power transmission device 402 and the received power value of the power receiving device 401 that are measured while changing the load. Also, through interpolation from multiple combinations, it is possible to estimate the power loss between the power transmission device 402 and the power receiving device 401 for all loads. A calibration process performed by the power transmission device 402 and the power receiving device 401 to obtain the combination of the transmitted power value and the received power value as mentioned earlier is hereinafter referred to as the “power-loss-method calibration (CAL) process.”

It is assumed that, when the power transmission device 402 actually transmits power to the power receiving device 401 at the third transmitted power value Pt3 after the CAL process, the power transmission device 402 receives a received power value Pr3′ from the power receiving device 401. The power transmission device 402 calculates the value Pr3−Pr3′ (=Pₗₒₛₛ3_FO) by subtracting the received power value Pr3′ actually received from the power receiving device 401 from the third received power value Pr3 in a state with no foreign object. This power value PₗₒₛₛFO can be considered, in the case where there is a foreign object in the vicinity of the power transmission device 402 and the power receiving device 401, as the power loss amount consumed by that foreign object. Thus, if the power value PₗₒₛₛFO that would have been consumed by the foreign object exceeds a predetermined threshold, it can be determined that the foreign object is present.

Alternatively, the power transmission device 402 obtains, in advance, a power loss amount Pt3−Pr3 (Pₗₒₛₛ3) between the power transmission device 402 and the power receiving device 401 from the third received power value Pr3 in a state with no foreign object. The power transmission device 402 then calculates a power loss amount Pt3−Pr3′ (Pₗₒₛₛ3′) between the power transmission device 402 and the power receiving device 401 in a state with a foreign object from the received power value Pr3′ received from the power receiving device 401 in a state with a foreign object. Then, Pₗₒₛₛ3′−Pₗₒₛₛ3 (=Pₗₒₛₛ_FO) may be used to estimate the power value Pₗₒₛₛ_FO that would have been consumed by the foreign object.

As mentioned earlier, the power value Pₗₒₛₛ_FO consumed by the foreign object may also be determined as Pr3−Pr3′ (=Pₗₒₛₛ_FO) or as Pₗₒₛₛ3′−Pₗₒₛₛ3 (=Pₗₒₛₛ_FO). In the present embodiment, basically the method of obtaining the power value Pₗₒₛₛ_FO as Pₗₒₛₛ3′−Pₗₒₛₛ3 (=Pₗₒₛₛ_FO) is described, but the method of obtaining the power value Pₗₒₛₛ_FO as Pr3−Pr3′ (=Pₗₒₛₛ_FO) is also applicable.

After the straight line 802 is obtained by the calibration process, the foreign object detection unit 305 of the power transmission device 402 periodically receives the current received power value (e.g., the received power value Pr3′ described above) from the power receiving device 401 via the communication unit 104. The current received power value that the power receiving device 401 periodically transmits is transmitted to the power transmission device 402 as a received power packet (mode 0). The foreign object detection unit 305 of the power transmission device 402 performs foreign object detection based on the received power value stored in the received power packet (mode 0) (hereinafter, RP0) as well as the straight line 802.

### Description of Each Phase Until Power Transmission is Executed

Foreign object detection using the power loss method is implemented during the transmission of power (a power transfer phase as described below) based on data obtained from a calibration phase as described below. In addition, foreign object detection using the Q-value measurement method is implemented before the transmission of power (before the transmission of a digital ping as described below, a negotiation phase, or a renegotiation phase).

The power receiving device 401 and the power transmission device 402 according to the present embodiment perform communication for power transmission/reception control based on the WPC standards. In the WPC standards, multiple phases are specified, including the power transfer phase in which power transmission is executed, and one or more phases before the actual transmission of power; and communication for power transmission/reception control required during each phase is performed. The phases before the transmission of power include the selection phase, ping phase, identification and configuration phase, negotiation phase, and calibration phase. Hereinafter, the identification and configuration phase is referred to as the I & C phase. The basic processing in each phase will be described below.

In the selection phase, the power transmission device 402 intermittently transmits an analog ping to detect that an object has been placed on the power transmission device 402 (e.g., that the power receiving device 401, a conductor piece, etc. has been placed on the charging stand 403). The power transmission device 402 detects at least one of the voltage value and the current value of the power transmission antenna 105 when transmitting an analog ping, and if the voltage value falls below a certain threshold or if the current value exceeds a certain threshold, the power transmission device 402 determines that there is an object and transitions to the ping phase.

In the ping phase, the power transmission device 402 transmits a digital ping with greater power than an analog ping. The magnitude of the power of a digital ping is power sufficient to activate the control unit 201 of the power receiving device 401 placed on the power transmission device 402. The power receiving device 401 notifies the power transmission device 402 of the received power value. In this way, the power transmission device 402 recognizes that the object detected during the selection phase is the power receiving device 401 by receiving a response from the power receiving device 401 that has received the digital ping. When the power transmission device 402 is notified of the received power value, the power transmission device 402 transitions to the I & C phase. The power transmission device 402 also measures the Q-value of the power transmission antenna (power transmission coil) 105 before transmitting a digital ping. The measurement result is used when executing foreign object detection processing using the Q-value measurement method.

In the I & C phase, the power transmission device 402 identifies the power receiving device 401 and obtains device configuration information (capability information) from the power receiving device 401. The power receiving device 401 sends an ID packet and a configuration packet. The ID packet includes identification information of the power receiving device 401, and the configuration packet includes device configuration information (capability information) of the power receiving device 401. Having received the ID packet and the configuration packet, the power transmission device 402 responds with an acknowledgment (ACK). Then, the I & C phase ends, transitioning to the next negotiation phase.

In the negotiation phase, the value of GP is determined based on the value of GP requested by the power receiving device 401, the power transmission capability of the power transmission device 402, and the like. In addition, the power transmission device 402 receives, from the power receiving device 401, an FOD status packet storing information about a reference quality factor value, and the setting unit 304 adjusts the threshold in the Q-value measurement method to determine the final threshold. Then, in accordance with a request from the power receiving device 401, the power transmission device 402 executes foreign object detection processing using the Q-value measurement method by the foreign object detection unit 305. Here, information about the reference quality factor value is information about the Q-value when the power receiving device 401 is placed on the power transmission device 402 in a state with no foreign object. In addition, the WPC standards specify a method of performing identical or similar processing to the negotiation phase again in response to a request from the power receiving device 401 after transitioning to the power transfer phase as described later. Hereinafter, the phase transitioning from the power transfer phase to perform these processes is referred to as the renegotiation phase.

In the calibration phase, the calibration process is performed based on the WPC standards. In addition, the power receiving device 401 notifies the power transmission device 402 of a certain received power value (received power value in the light load state/received power value in the maximum load state), and the power transmission device 402 makes adjustments for efficiently transmitting power. The received power value reported to the power transmission device 402 is used for foreign object detection processing using the power loss method.

In the power transfer phase, control is performed for the start and continuation of power transmission, as well as the cessation of power transmission due to an error or full charging. The power transmission device 402 and the power receiving device 401, using the power transmission antenna 105 and the power receiving antenna 205 used in performing wireless power transmission based on the WPC standards for the aforementioned power transmission/reception control, perform communication by superimposing signals on electromagnetic waves transmitted from these antennas. Note that the range within which the power transmission device 402 and the power receiving device 401 can communicate based on the WPC standards is substantially the same as the range within which the power transmission device 402 can transmit power.

### Flow of Process for Power Transmission According to WPC Standards

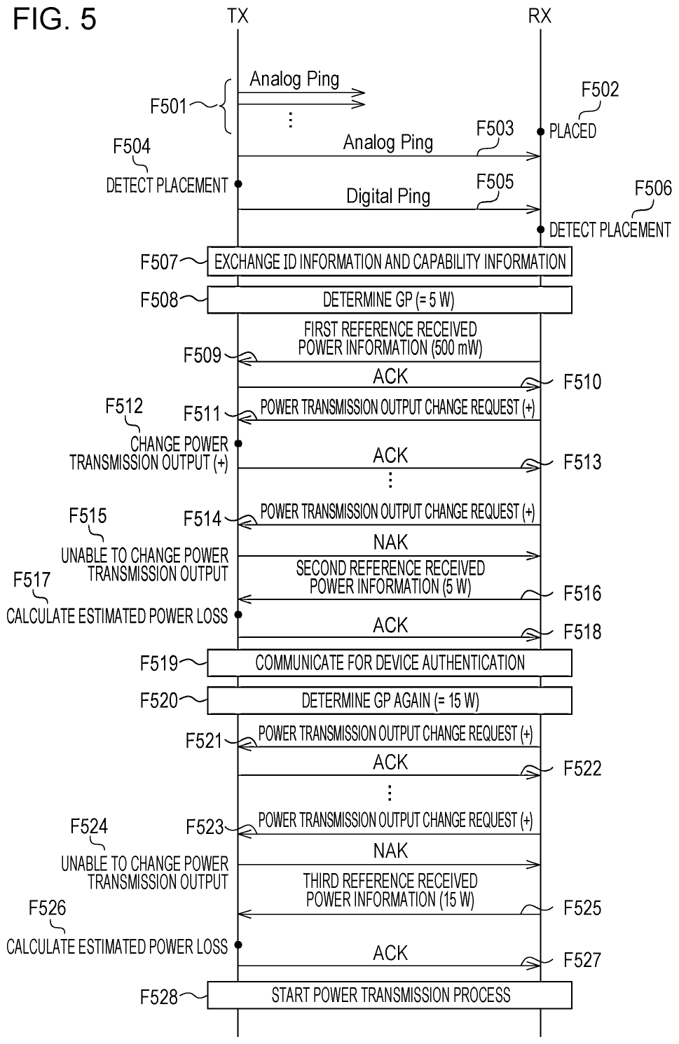

As mentioned earlier, the WPC standards specify the selection phase, ping phase, I & C phase, negotiation phase, calibration phase, and power transfer phase. Hereinafter, the operation of the power transmission device 402 and the power receiving device 401 during these phases will be described using the sequence diagram illustrated in FIG. 5. FIG. 5 is a diagram for describing a sequence for power transmission according to the WPC standards. Here, the power transmission device 402 and the power receiving device 401 will be described by way of example.

First, the power transmission device 402 performs repeated intermittent transmission of an analog ping of the WPC standards in order to detect objects present within the power transmittable range (F501). The power transmission device 402 executes the processing specified as the selection phase and the ping phase in the WPC standards and waits for the power receiving device 401 to be placed. The user of the power receiving device 401 brings the power receiving device 401 (e.g., a smartphone) closer to the power transmission device 402 in order to charge the power receiving device 401 (F502). For example, by placing the power receiving device 401 on the power transmission device 402, the power receiving device 401 is brought closer to the power transmission device 402.

When the power transmission device 402 detects the presence of an object within the power transmittable range through the transmitted analog ping (F503, F504), the power transmission device 402 transmits a digital ping of the WPC standards (F505). Upon receiving the digital ping, the power receiving device 401 grasps that the power transmission device 402 has detected the power receiving device 401 (F506). In response to a certain response to the digital ping, the power transmission device 402 also determines that the detected object is the power receiving device 401, and that the power receiving device 401 has been placed on the charging stand 403. In response to detection of the placement of the power receiving device 401, the power transmission device 402 obtains identification information and capability information from the power receiving device 401 through communication in the I & C phase specified by the WPC standards (F507).

Here, the identification information of the power receiving device 401 includes a manufacturer code and a basic device ID. The capability information of the power receiving device 401 includes an information element that can identify the version of the WPC standards that the power receiving device 401 supports, as well as a value (maximum power value) that identifies the maximum power that the power receiving device 401 can supply to a load. The capability information of the power receiving device 401 further includes information indicating whether the power receiving device 401 has the negotiation function of the WPC standards. Note that the power transmission device 402 may obtain the identification information and capability information of the power receiving device 401 using a method other than communication in the I & C phase of the WPC standards. The identification information may also be any other identification information that can identify the individual power receiving device 401, such as a wireless power ID. The capability information may include information other than the above.

Then, the power transmission device 402 determines the value of GP with the power receiving device 401 through communication in the negotiation phase specified by the WPC standards (F508). Note that F508 is not limited to communication in the negotiation phase of the WPC standards, and other procedures for determining GP may be executed. Additionally, if the power transmission device 402, when, for example, obtaining information in F507, obtains information indicating that the power receiving device 401 does not support the negotiation phase, no communication will be performed in the negotiation phase, and the value of GP may be set as a small value (for example, as predetermined by the WPC standards). In the present embodiment, it is assumed that, in F508, GP is determined to be 5 watts.

After determining GP, the power transmission device 402 transitions to the calibration phase and performs a calibration process based on this GP. In the calibration process, the power receiving device 401 first sends to the power transmission device 402 information (first reference received power information) including the received power in a light load state (a load-disconnected state or a load state in which the transmitted power is less than or equal to a first threshold) (F509).

It is assumed that the first reference received power information in the present embodiment is the received power information of the power receiving device 401 when the transmitted power of the power transmission device 402 is 250 milliwatts. The first reference received power information is sent by being stored in a received power packet (mode 1) (hereinafter, RP1) as specified by the WPC standards, but it is acceptable to use other messages. The power transmission device 402 determines whether to accept the first reference received power information based on the power transmission state of itself. The power transmission device 402 sends to the power receiving device 401 an acknowledgment response=ACK if it accepts the first reference received power information, and a negative acknowledgment=NAK if it does not accept the first reference received power information (F510).

Next, upon receiving ACK from the power transmission device 402, the power receiving device 401 performs a process for transmitting to the power transmission device 402 information (second reference received power information) including the received power in a load-connected state (a maximum load state or a load state in which the transmitted power is greater than or equal to a second threshold). In the present embodiment, since GP is 5 watts at this moment, it is assumed that the second reference received power information is the received power information of the power receiving device 401 when the transmitted power of the power transmission device 402 is 5 watts. Here, the second reference received power information is stored in a received power packet (mode 2) (hereinafter, RP2) as specified by the WPC standards, but it is acceptable to use other messages. First, as a step before sending the second reference received power information, the power receiving device 401 sends a power transmission output change instruction including a positive value in order to increase the transmitted power from the power transmission device 402 to 5 watts (F511).

The power transmission device 402 receives the aforementioned power transmission output change instruction, and, if it is capable of accommodating an increase in the transmitted power, it responds with an ACK and increases the transmitted power (F512, F513). Thereafter, F511 to F513 are repeated to increase the transmitted power. Since the second reference received power information is the received power information when the transmitted power of the power transmission device 402 is 5 watts, if the power transmission device 402 receives a power increase request exceeding 5 watts from the power receiving device 401 (F514), the power transmission device 402 responds with a NAK in response to the power transmission output change instruction (F515). This prevents the transmission of power exceeding the specified limit.

The power receiving device 401 recognizes that the specified transmitted power has been reached upon receiving a NAK from the power transmission device 402. Then, the power receiving device 401 stores information including the received power in a load-connected state (second reference received power information) in RP2 and sends it to the power transmission device 402 (F516). The power transmission device 402 can calculate the power loss amount between the power transmission device 402 and the power receiving device 401 in a load-disconnected state as well as in a load-connected state based on the transmitted power value of the power transmission device 402 and the received power values included in the first and second reference received power information. Moreover, by interpolating between these power loss amounts, it is possible to calculate the power loss amount between the power transmission device 402 and the power receiving device 401 for all possible magnitudes of transmitted power available to the power transmission device 402 (in this case, from 250 milliwatts to 5 watts) (F517). The power transmission device 402 sends an ACK in response to the second reference received power information from the power receiving device 401 (F518), and completes the calibration process.

If the power transmission device 402, which has determined that a charging process can be started, starts a power transmission process for the power receiving device 401, it transitions to the power transfer phase, and the charging of the power receiving device 401 is started. Before the start of the power transmission process, the power transmission device 402 and the power receiving device 401 perform a device authentication process (F519), and if it is determined that both of the devices can accommodate a larger GP, the GP may be reset to a larger value, such as 15 watts (F520).

In this case, the power receiving device 401 and the power transmission device 402 perform identical or similar processing to the processing in F511 to F515 in order to increase the transmitted power of the power transmission device 402 to 15 watts (F521 to F524). The power transmission device 402 and the power receiving device 401 then perform the calibration process again for GP=15 watts. Specifically, the power receiving device 401 sends information (third reference received power information) including the received power in a load-connected state of the power receiving device 401 when the transmitted power of the power transmission device 402 is 15 watts (F525). The power transmission device 402 calculates the power loss amount between the power transmission device 402 and the power receiving device 401 for all possible magnitudes of transmitted power available to the power transmission device 402 (from 250 milliwatts to 15 watts) based on the received power included in the first, second, and third reference received power information (F526). The power transmission device 402 sends an ACK in response to the third reference received power information from the power receiving device 401 (F527), and completes the calibration process. The power transmission device 402, which has determined that a charging process can be started, starts a power transmission process for the power receiving device 401, and it transitions to the power transfer phase (F528).

In the power transfer phase, the power transmission device 402 transmits power to the power receiving device 401. In addition, foreign object detection using the power loss method is performed. In the power loss method, the power transmission device 402 first calculates the power loss amount Pₗₒₛₛ3 between the power transmission device 402 and the power receiving device 401 in a state with no foreign object based on the difference between the power transmitted by the power transmission device 402 and the power received by the power receiving device 401 through the above-mentioned calibration process. The calculated value corresponds to a reference power loss amount in a normal state (a state with no foreign object) during the power transmission process. Then, if the power loss amount Pₗₒₛₛ3′ between the power transmission device 402 and the power receiving device 401 measured during the transmission of power after the calibration process deviates from the power loss amount in the normal state by a threshold or more, the power transmission device 402 determines that there is a “foreign object.”

So far the power loss method has been described. The power loss method is for performing foreign object detection based on the result of measuring the power loss during transmission of power from the power transmission device 402 to the power receiving device 401. Foreign object detection using the power loss method is disadvantageous in that the accuracy of foreign object detection decreases when the power transmission device 402 is transmitting a large amount of power, but, on the other hand, is advantageous in that the power transmission efficiency can be maintained high because foreign object detection can be performed while continuing the transmission of power.

As described above, during the power transfer phase, foreign object detection using the power loss method can be performed. However, foreign object detection using the power loss method alone may lead to possibilities of false detection of foreign objects, as well as false determinations that there are no foreign objects despite their presence. In particular, the power transfer phase is the phase in which the power transmission device 402 transmits power, and, if a foreign object is present in the vicinity of the power transmission device 402 and the power receiving device 401 during power transmission, heat generation, etc. from the foreign object increases. Therefore, it is desirable to improve the accuracy of foreign object detection during this phase. Accordingly, in the present embodiment, in order to improve the accuracy of foreign object detection, a waveform decay method is implemented as a foreign object detection method different from the power loss method.

### Foreign Object Detection Method Using Waveform Decay Method

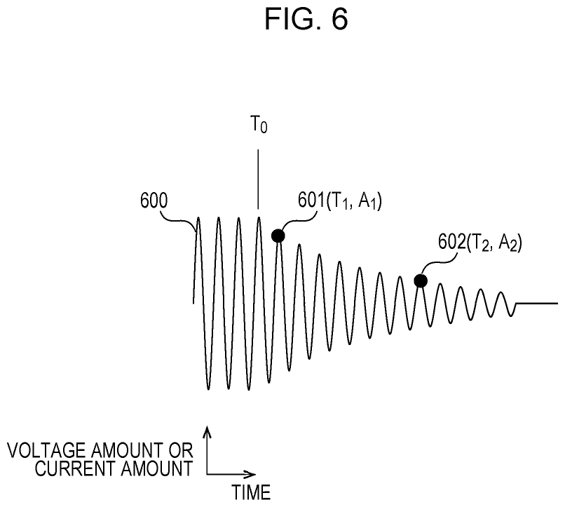

In the power transfer phase, the power transmission device 402 transmits power to the power receiving device 401. Therefore, if it is possible to detect a foreign object using the transmitted power waveform (voltage waveform or current waveform) pertaining to this power transmission, it will be possible to detect a foreign object without using newly-defined foreign object detection signals or the like. Hereinafter, a method of performing foreign object detection based on an attenuation state (decay state) of the transmitted power waveform (waveform attenuation method (decay method)) will be described using FIG. 6. FIG. 6 is a diagram for describing the principle of foreign object detection using the waveform decay method. Here, foreign object detection using the transmitted power waveform pertaining to transmission of power from the power transmission device 402 to the power receiving device 401 will be described by way of example.

In FIG. 6, the waveform indicates changes over time of a voltage value 600 (hereinafter, simply referred to as a voltage value) of a high-frequency voltage applied to the power transmission antenna 105 of the power transmission device 402. The horizontal axis in FIG. 6 represents time, whereas the vertical axis represents voltage value. It is assumed that the power transmission device 402 is transmitting power to the power receiving device 401 via the power transmission antenna 105, and stops transmitting power at time T₀. That is, at time T₀, the power supply for power transmission from the power supply unit 102 is stopped. The frequency of the transmitted power waveform pertaining to power transmission from the power transmission device 402 is a certain frequency, such as a fixed frequency between 85 kHz and 205 kHz as used in the WPC standards. A point 601 is a point on the envelope of the high-frequency voltage, and represents the voltage value at time T₁. At the point 601, (T₁, A₁) indicates that the voltage value at time T₁ is A₁. Similarly, a point 602 is also a point on the envelope of the high-frequency voltage, and represents the voltage value at time T₂. At the point 602, (T₂, A₂) indicates that the voltage value at time T₂ is A₂. The quality coefficient (Q-value) of this power transmission antenna 105 can be obtained based on changes over time of the voltage value since time T₀. For example, based on the time, voltage value, and frequency f of the high-frequency voltage at the points 601 and 602 on the envelope of the voltage value, the Q-value is calculated by equation (1):

$$Q = π f ( {T}_{2} - {T}_{1} ) / ln ( {A}_{1} / {A}_{2} ) \qquad equation ( 1 )$$

If a foreign object is present in the vicinity of the power transmission device 402 and the power receiving device 401, this Q-value decreases. This is because in the presence of a foreign object, energy loss occurs due to the foreign object. Therefore, focusing on the slope of the attenuation of the voltage value, in the presence of a foreign object, the loss of energy due to the foreign object occurs as compared to the absence of a foreign object, making the slope of a straight line connecting the point 601 and the point 602 steeper, and increasing the attenuation rate of the amplitude of the waveform. That is, the waveform decay method is for determining the presence or absence of a foreign object based on the decay state of the voltage value between the point 601 and the point 602, and in actually determining the presence or absence of a foreign object, the determination can be made by comparing some numerical value representing the decay state. For example, the determination can be made using the above-described Q-value.

A lower Q-value means a higher waveform attenuation rate (degree of amplitude reduction of the waveform per unit time). Alternatively, the determination may be made using the slope of the straight line connecting the point 601 and the point 602, as obtained from (A₁−A₂)/(T₂−T₁). Alternatively, if the times (T₁ and T₂) for observing the decay state of the voltage value are fixed, the determination may be made using (A₁-A₂) representing the voltage value difference or (A₁/A₂) representing the value the voltage value ratio. Alternatively, if the voltage value A₁ immediately after the cessation of the power transmission is constant, the determination may be made using the voltage value A₂ after a certain time has elapsed. Alternatively, the determination may be made using the value of time (T₂−T₁) involved in the voltage value A₁ becoming the certain voltage value A₂.

As mentioned earlier, the presence or absence of a foreign object can be determined based on the decay state of the voltage value during a period in which power transmission is stopped, and there are multiple values representing the decay state. These values representing the decay state are referred to as “waveform attenuation indices” in the present embodiment. For example, as mentioned earlier, the Q-value calculated by equation (1) is a value representing the decay state of the voltage value pertaining to power transmission, and is included in the “waveform attenuation indices.” The waveform attenuation indices are all values corresponding to the waveform attenuation rate. Note that, in the waveform decay method, the waveform attenuation rate itself may be measured as a “waveform attenuation index.” In the following, the case of using the waveform attenuation rate as a waveform attenuation index will be mainly described, but the contents of the present embodiment can be applied in the same way when other waveform attenuation indices are used.

Note that, when the vertical axis in FIG. 6 represents the current value flowing through the power transmission antenna 105, as in the case of the voltage value, the decay state of the current value during a period in which power transmission is stopped changes depending on the presence or absence of a foreign object. Then, in the presence of a foreign object, the waveform attenuation rate becomes higher than in the absence of a foreign object. Accordingly, even if the method described above is applied to changes over time of the current value flowing through the power transmission antenna 105, a foreign object can still be detected. That is, a foreign object can be detected by determining the presence or absence of a foreign object using the Q-value obtained from the current waveform, the slope of the attenuation of the current value, the current value difference, the current value ratio, the absolute value of the current value, and the time involved in the current value becoming a certain current value as waveform attenuation indices. That is, it is assumed that the waveform decay method is a method of performing foreign object detection by measuring a voltage value or a current value at at least two time points in a certain period during which the power transmission device 402 restricts power transmission. Note that it is acceptable to use measurements at three or more time points.

In addition, foreign object detection based on both the decay state of the voltage value and the decay state of the current value may be performed, such as determining the presence or absence of a foreign object using evaluation values calculated from the waveform attenuation index of the voltage value and the waveform attenuation index of the current value. Note that, although the waveform attenuation index in a period during which the power transmission device 402 temporarily stops transmitting power is measured in the above-described example, the waveform attenuation index in a period during which the power transmission device 402 temporarily lowers the power supplied from the power supply unit 102 from a certain power level to a lower power level may be measured.

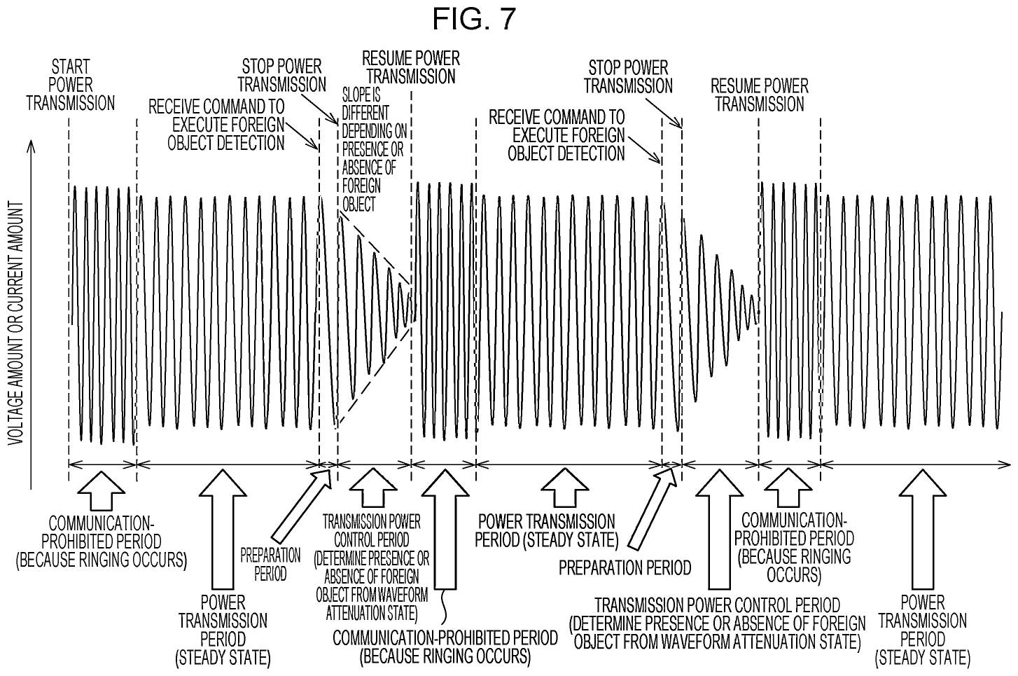

The method of performing foreign object detection based on the transmitted power waveform during power transmission using the waveform decay method will now be described with reference to FIG. 7. In FIG. 7, the transmitted power waveform when performing foreign object detection using the waveform decay method is depicted, the horizontal axis representing time, whereas the vertical axis representing the voltage value of the power transmission antenna 105. As in FIG. 6, the horizontal axis may represent the current value of the current flowing through the power transmission antenna 105.

In a transient response period immediately after the power transmission device 402 starts transmitting power, the transmitted power waveform is unstable. Therefore, during the transient response period in which the transmitted power waveform is unstable, the power receiving device 401 applies control not to perform communication (communication through amplitude modulation or load modulation) with the power transmission device 402. The power transmission device 402 similarly applies control not to communicate with the power receiving device 401 (communication through frequency shift keying modulation). Hereinafter, this period is referred to as a communication-prohibited period. During this communication-prohibited period, the power transmission device 402 still transmits power to the power receiving device 401. After going through the communication-prohibited period, the power transmission device 402 continues transmitting power to the power receiving device 401. Hereinafter, the period in this steady state is referred to as a power transmission period.

Upon receiving a foreign object detection execution request packet (command) from the power receiving device 401, the power transmission device 402 temporarily stops transmitting power after a certain period of time has elapsed. Alternatively, the power transmission device 402 temporarily lowers the transmitted power. Hereinafter, this certain period is referred to as a preparation period. Note that this foreign object detection execution request packet may be RP0, RP1, or RP2 mentioned earlier. Then, the power transmission control unit 302 of the power transmission device 402 stops transmitting power or temporarily lowers the transmitted power after the preparation period has elapsed. This attenuates the amplitude of the transmitted power waveform. Hereinafter, the period from when the power transmission device 402 temporarily stops or lowers the transmitted power to when the power transmission device 402 starts to resume the power transmission is referred to as a transmission power control period. The power transmission device 402 calculates a waveform attenuation index of this attenuation waveform, compares the calculated waveform attenuation index with a threshold, and determines the presence or absence of a foreign object or the possibility of the presence (presence probability) of a foreign object. The determination may be implemented during the transmission power control period, or may be implemented during the communication-prohibited period or the power transmission period.

If no foreign object is detected after the transmission power control period has elapsed, the power transmission device 402 resumes the power transmission. Since the transmitted power waveform is unstable in the transient response period immediately after resuming the power transmission, this period again becomes a communication-prohibited period. Then, the period transitions to the power transmission period in which the power transmission device 402 stably transmits power to the power receiving device 401.

As mentioned earlier, the power transmission device 402 repeatedly undergoes the power transmission start, the communication-prohibited period, the power transmission period, and the transmission power control period. Then, the power transmission device 402 calculates a waveform attenuation index of the attenuation waveform at a certain timing, compares the calculated waveform attenuation index with a threshold, and determines the presence or absence of a foreign object or the possibility of the presence (presence probability) of a foreign object.

Note that, in the transmission power control period, when elements such as the power receiving unit 203, the charging unit 206, and the battery 207 are connected to the power receiving antenna 205 and the resonant capacitor 211 of the power receiving device 401, the waveform attenuation index may be affected by loads due to these elements. That is, the waveform attenuation index may change depending on the state of the power receiving unit 203, the charging unit 206, and the battery 207. Therefore, even if the waveform attenuation index is large, it may be difficult to distinguish whether it is due to the influence of a foreign object or due to changes in the state of the power receiving unit 203, the charging unit 206, the battery 207, etc.

Therefore, when observing the waveform attenuation index and performing foreign object detection, the power receiving device 401 may disconnect the first switch unit 209 during the aforementioned preparation period. This makes it possible to eliminate the influence of the battery 207. Alternatively, the second switch unit 210 may be turned ON and short-circuited to cause current to flow through a closed loop formed of the power receiving antenna 205, the resonant capacitor 211, and the second switch unit 210. This makes it possible to eliminate the influence of the power receiving unit 203, the charging unit 206, and the battery 207, and, by performing foreign object detection based on the waveform attenuation index of the waveform observed in such a state, highly accurate foreign object detection can be performed.

Alternatively, the power receiving device 401 may apply control to turn ON the first switch unit 209 to be short-circuited and to turn OFF the second switch unit 210 to be disconnected, thus transitioning to a low power consumption mode or making the power consumption constant. If the power consumed by the power receiving device 401 is not constant or if a large amount of power is consumed, the waveform attenuation index of the attenuation waveform is affected by these fluctuations in the power consumption. Accordingly, in order to eliminate the influence of these factors, the power consumed by the power receiving device 401 is controlled. Specifically, the operation of applications running on the power receiving device 401 are limited or stopped, and the hardware functions of the power receiving device 401 are turned into a low power consumption mode or an operation stop mode. By performing foreign object detection based on the waveform attenuation index of the waveform observed in such a state, highly accurate foreign object detection can be performed.

Likewise, the power transmission device 402 may turn ON the switch 108 to be short-circuited during the aforementioned preparation period, leading to a state in which current flows through a closed loop formed of the power transmission antenna 105, the resonant capacitor 107, and the switch 108. This makes it possible to eliminate the influence of the power supply unit 102, the power transmission unit 103, and the communication unit 104. Alternatively, it is possible to eliminate the influence of the power supply unit 102, the power transmission unit 103, and the communication unit 104 by providing a switch (not illustrated) between the power transmission antenna 105 and the power transmission unit 103, and disconnecting the switch during the aforementioned preparation period.

### Determination Method for Each Period in Case of Using Waveform Decay Method as Foreign Object Detection Method

Next, the method of determining the aforementioned preparation period will be described. As the method of determining the preparation period, a predetermined fixed value (time) may be used. In addition, the power transmission device 402 may determine the time in accordance with the state of the power transmission device 402 and notify the power receiving device 401 of the determined time. Alternatively, the power receiving device 401 may determine the time in accordance with the state of the power receiving device 401 and notify the power transmission device 402 of the determined time.

Moreover, as another determination method, the time may be determined by the power transmission device 402 and the power receiving device 401 communicating and exchanging information with each other. For example, the power transmission device 402 determines the maximum time of the preparation period and notifies the power receiving device 401 thereof, whereas the power receiving device 401 determines the minimum time of the preparation period and notifies the power transmission device 402 thereof. Then, the power receiving device 401 may determine the preparation period as a value (time) within a range set by the power transmission device 402 and the power receiving device 401, and notify the power transmission device 402 of the value. The relationship between the power transmission device 402 and the power receiving device 401 may be reversed. By setting the preparation period at an appropriate time, it is possible to prevent the waveform in the transmission power control period from being disturbed.

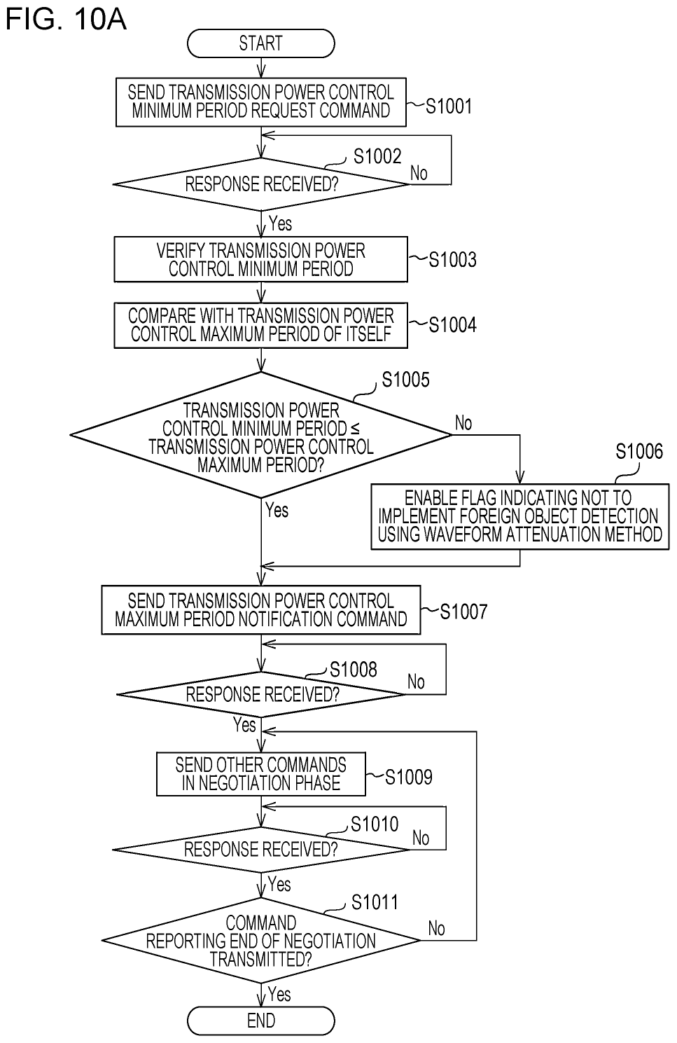

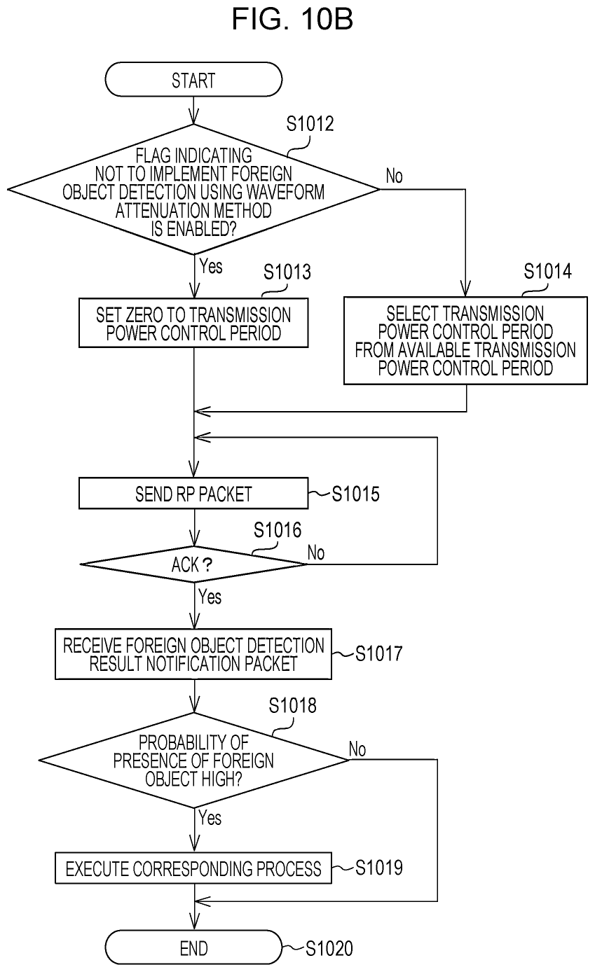

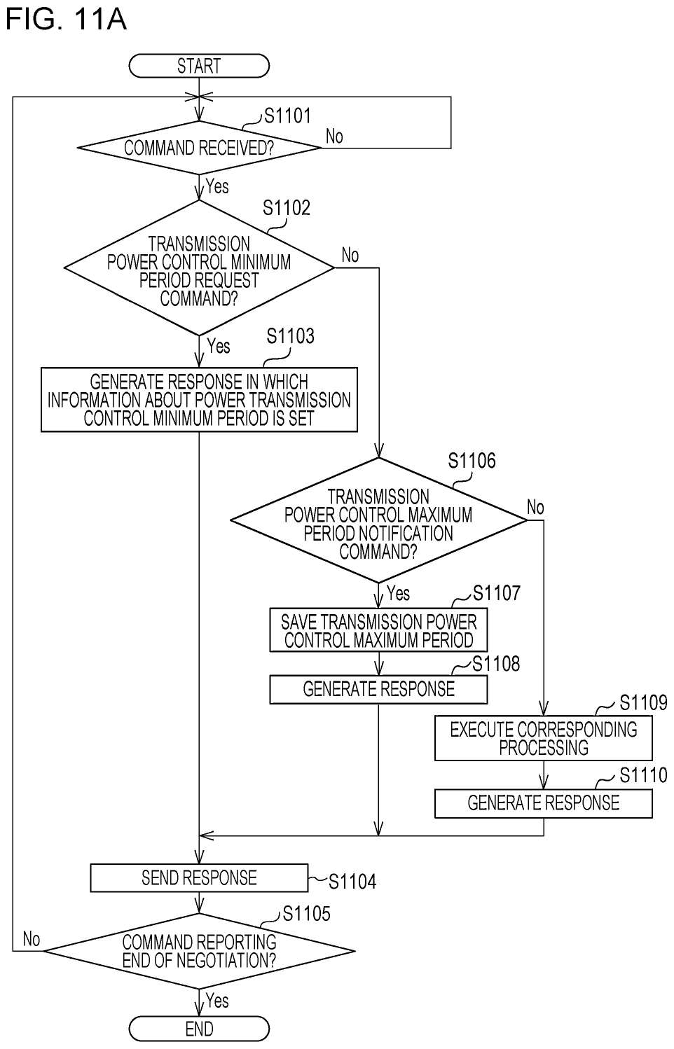

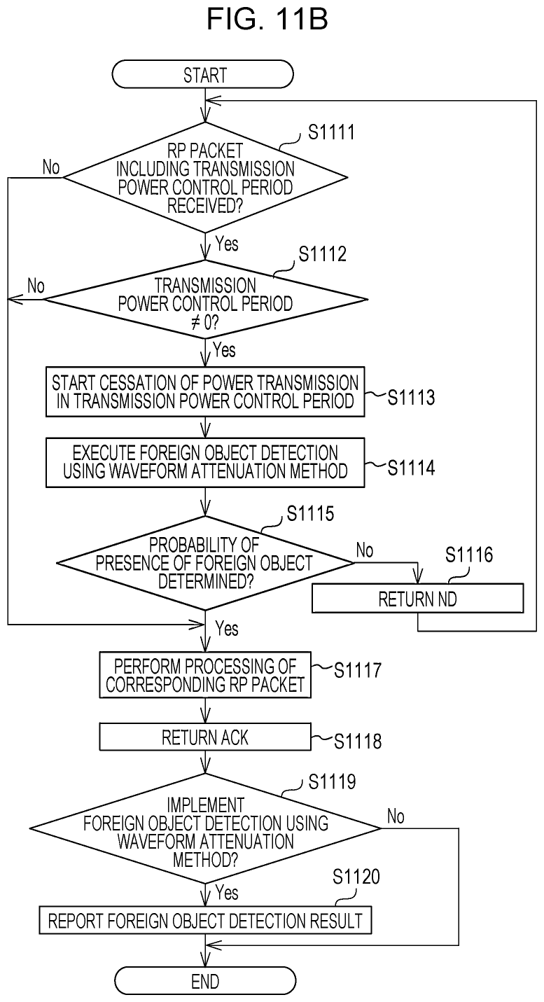

Next, the method of determining the aforementioned transmission power control period will be described. In the method of setting the transmission power control period, it is important to determine the transmission power control period that can be accommodated by both the power transmission device 402 and the power receiving device 401. Therefore, during the negotiation phase, the power transmission device 402 and the power receiving device 401 notify each other of their capabilities for the transmission power control period that they can accommodate, thereby determining the actual transmission power control period from within their common range. Specifically, it is realized with two types of commands issued by the power receiving device 401. Note that detailed procedures will be described later with reference to FIGS. 10A, 10B, 11A, and 11B.

As the first one, a command (hereinafter referred to as a “transmission power control minimum period request command”) to obtain information about the minimum value of the transmission power control period (hereinafter referred to as the “transmission power control minimum period”) that can be generated by the power transmission device 402 is issued by the power receiving device 401. Here, the transmission power control minimum period that can be generated by the power transmission device 402 includes at least the period necessary for the power transmission device 402 to perform foreign object detection using the waveform decay method, which will be described in detail later. As the second one, a command (hereinafter referred to as a “transmission power control maximum period notification command”) for reporting information about the maximum value of the transmission power control period (hereinafter referred to as the “transmission power control maximum period”) that the power receiving device 401 can accommodate is issued by the power receiving device 401. Here, the transmission power control maximum period that the power receiving device 401 can accommodate is defined within a range in which the power transmission is not determined to be stopped, which will be described in details later.

With these two commands, the power receiving device 401 and the power transmission device 402 can grasp each other's capabilities regarding the transmission power control period. Then, if the condition “(transmission power control minimum period that can be generated by the power transmission device 402) (transmission power control maximum period that the power receiving device 401 can accommodate)” is satisfied, the transmission power control period can be determined from within that range. In addition, in the exchange of the above-described commands, if it is undesirable to implement foreign object detection using the waveform decay method, the intention of not performing foreign object detection using the waveform decay method can be reported by setting “0” to the value of the transmission power control minimum period or the transmission power control maximum period set in the RP packet.

Here, the relationship between the transmitted power from the power transmission device 402 and the transmission power control period will be described. In the exchange of information between the power transmission device 402 and the power receiving device 401, in addition to the method described above, the transmission power control period is determined such that the larger the power transmitted by the power transmission device 402, the shorter the transmission power control period. When power transmission is resumed after the transmission power control period has elapsed, ringing occurs in the transmitted power waveform at the timing of resuming power transmission. The greater the difference in magnitude of transmitted power before and after resuming power transmission, the larger the ringing occurs. Therefore, in order to reduce the ringing, it is necessary to reduce the difference in magnitude of transmitted power before and after resuming power transmission.

If the transmission power control period is shortened, power transmission will be resumed with less waveform attenuation, and, as a result, the difference in magnitude of transmitted power will be small, making it possible to suppress ringing.

In this way, by making the transmission power control period shorter as the transmitted power becomes larger, it becomes possible to reduce the difference in magnitude of transmitted power at the time of resuming power transmission and suppressing the ringing. In the meanwhile, conversely, it may be acceptable to make the transmission power control period longer as the transmitted power becomes larger. When the transmitted power is large, highly accurate foreign object detection is required. Therefore, when the transmitted power is large, the transmission power control period is extended to observe the decay state for a longer period of time. This makes it possible to realize more accurate foreign object detection than when the transmitted power is small.

Next, the method of determining the aforementioned communication-prohibited period will be described. Since ringing occurs in the transmitted power waveform after the power transmission is resumed, stable communication is realized by not performing communication in a state where ringing is occurring. As the method of determining the communication-prohibited period, like the method of determining the preparation period, a predetermined fixed value (time) may be used. In addition, the power transmission device 402 may determine the time in accordance with the state of the power transmission device 402 and notify the power receiving device 401 of the determined time. Alternatively, the power receiving device 401 may determine the time in accordance with the state of the power receiving device 401 and notify the power transmission device 402 of the determined time.

Alternatively, as another determination method, the time may be determined by the power transmission device 402 and the power receiving device 401 communicating and exchanging information with each other. For example, the power transmission device 402 determines the maximum time of the communication-prohibited period and notifies the power receiving device 401 thereof, whereas the power receiving device 401 determines the minimum time of the communication-prohibited period and notifies the power transmission device 402 thereof. Then, the power receiving device 401 may determine the communication-prohibited period as a value (time) within a range set by the power transmission device 402 and the power receiving device 401, and notify the power transmission device 402 of the value. In addition, the relationship between the power transmission device 402 and the power receiving device 401 may be reversed. In this case, the power transmission device 402 or the power receiving device 401 may determine the minimum time within the range set by the power transmission device 402 and the power receiving device 401 as the communication-prohibited period. Alternatively, the power transmission device 402 or the power receiving device 401 may determine the maximum time within the range set by the power transmission device 402 and the power receiving device 401 as the communication-prohibited period.

Here, the relationship between the transmitted power from the power transmission device 402 and the communication-prohibited period will be described. In the exchange of information between the power transmission device 402 and the power receiving device 401, in addition to the method described above, the communication-prohibited period is determined such that the larger the power transmitted by the power transmission device 402, the shorter the communication-prohibited period. As mentioned earlier, the greater the difference in magnitude of transmitted power when resuming power transmission, the larger the ringing. Therefore, a longer communication-prohibited period is provided so that the ringing converges or becomes sufficiently small. This allows for stable communication to be performed between the power transmission device 402 and the power receiving device 401. Note that, conversely, it may also be acceptable to make the communication-prohibited period shorter as the transmitted power becomes larger.

The relationship between the transmission power control period and the communication-prohibited period will now be described. In the exchange of information between the power transmission device 402 and the power receiving device 401, in addition to the method described above, the communication-prohibited period is determined such that the longer the transmission power control period, the longer the communication-prohibited period. As mentioned earlier, the greater the difference in magnitude of transmitted power when resuming power transmission, the larger the ringing. Therefore, as the transmission power control period becomes longer, the waveform attenuation also becomes larger, and as a result, the difference in magnitude of transmitted power when resuming power transmission will be larger, and the ringing also will be larger. Therefore, by making the communication-prohibited period longer as the transmission power control period becomes longer, it becomes possible to perform communication only after the ringing has converged or become sufficiently small, thus allowing for stable communication to be performed between the power transmission device 402 and the power receiving device 401. Note that, conversely, it may also be acceptable to make the communication-prohibited period shorter as the transmission power control period becomes longer.

Next, the method of determining the aforementioned power transmission power control period will be described. As the method of determining the power transmission power control period, like the method of determining the preparation period and the communication-prohibited period, a predetermined fixed value (time) may be used. In addition, the power transmission device 402 may determine the time in accordance with the state of the power transmission device 402 and notify the power receiving device 401 of the determined time. Alternatively, the power receiving device 401 may determine a certain value (time) in accordance with the state of the power receiving device 401 and notify the power transmission device 402 of the determined time.

Alternatively, as another determination method, the time may be determined by the power transmission device 402 and the power receiving device 401 communicating and exchanging information with each other. For example, the power transmission device 402 determines the maximum time of the power transmission power control period and notifies the power receiving device 401 thereof, whereas the power receiving device 401 determines the minimum time of the power transmission power control period and notifies the power transmission device 402 thereof. Then, the power receiving device 401 may determine the power transmission power control period as a value (time) within a range set by the power transmission device 402 and the power receiving device 401, and notify the power transmission device 402 of the value. In addition, the relationship between the power transmission device 402 and the power receiving device 401 may be reversed.

Here, the relationship between the transmitted power from the power transmission device 402 and the power transmission period will be described. In the exchange of information between the power transmission device 402 and the power receiving device 401, in addition to the method described above, the power transmission period is determined such that the larger the power transmitted by the power transmission device 402, the shorter the power transmission period. As mentioned earlier, when the transmitted power is large, highly accurate foreign object detection is required. Therefore, the power transmission period is made shorter as the transmitted power becomes larger, thereby increasing the number of times the transmission power control period is repeated within a certain time. This makes it possible to increase the number of times waveform attenuation is observed to increase chances of detecting a foreign object, enabling highly accurate foreign object detection. In the meanwhile, conversely, it may be acceptable to make the power transmission period longer as the transmitted power becomes larger. This makes it possible to transmit power from the power transmission device 402 to the power receiving device 401 without reducing the transmission efficiency of the transmitted power.

### Method of Setting Threshold Pertaining to Foreign Object Detection in Waveform Decay Method

Next, a method of setting a threshold for determining the presence or absence of a foreign object or the possibility of the presence (presence probability) of a foreign object when performing foreign object detection using the waveform decay method will be described. As mentioned earlier, in the waveform decay method, foreign object detection is performed based on a waveform attenuation index. In other words, the measured waveform attenuation index is compared with a certain threshold, and, based on the comparison result, the presence or absence of a foreign object or the possibility of the presence of a foreign object is determined. As the method of setting the threshold, the following methods are available.

The first is a method for the power transmission device 402 to retain a predetermined fixed value as a threshold, as a common value independent of the power receiving device 401 to which power is transmitted. Note that this fixed value may be the same value in any case, or may be a value determined by the power transmission device 402 according to the situation. As mentioned earlier, the transmitted power waveform during the transmission power control period has a higher waveform attenuation rate in the presence of a foreign object. Therefore, a waveform attenuation index when no foreign object is expected to be present is retained in advance as a certain value, and this value is then used as a threshold against which the result of measuring the waveform attenuation index is compared. If the result indicates that the measured waveform attenuation index is greater than the threshold, it is determined that there is a foreign object or the possibility of the presence of a foreign object is high.

For example, if the waveform attenuation index is designated as the Q-value, the Q-value measured by the power transmission device 402 is compared with a Q-value (threshold) when no foreign object is expected to be present. Then, if the measured Q-value is less than the threshold, it is determined that there is a foreign object or there is a possibility of the presence of a foreign object. In addition, if the measured Q-value is greater than or approximately equal to the threshold, it is determined that there is no foreign object or the possibility of the presence of a foreign object is low. As mentioned earlier, by using the first method, foreign object detection using the waveform decay method can be performed.

The second is a method for the setting unit 304 of the power transmission device 402 to adjust the threshold based on information sent from the power receiving device 401 to determine the final threshold. Like the first method, a waveform attenuation index when no foreign object is expected to be present is retained in advance as a certain value, and this is used as a threshold against which the result of measuring the waveform attenuation index is compared. If the result indicates that the measured waveform attenuation index is greater than the threshold, it is determined that there is a foreign object or the possibility of the presence of a foreign object is high. Here, the measured value of the waveform attenuation index may differ depending on the power receiving device 401 to which power is transmitted, which is placed on the power transmission device 402. This is because the electrical characteristics of the power receiving device 401 coupled via the power transmission antenna 105 of the power transmission device 402 affect the value of the waveform attenuation index.

For example, if the waveform attenuation index is designated as the Q-value, the Q-value measured by the power transmission device 402 in the absence of a foreign object may differ depending on the power receiving device 401 placed on the power transmission device 402. Therefore, the power receiving device 401 retains information about the Q-value for each power transmission device 402 when the power receiving device 401 is placed on the power transmission device in the absence of a foreign object, and communicates with and notifies the power transmission device 402 of the Q-value. The power transmission device 402 then adjusts the threshold based on the information about the Q-value received from the power receiving device 401 to determine the final threshold.

As mentioned earlier, the power transmission device 402 receives, during the negotiation phase, an FOD status packet in which information about a reference quality factor value is stored, and adjusts the threshold in the Q-value measurement method. The power transmission device 402 then determines the final threshold in the Q-value measurement method. Therefore, similarly, in the case of foreign object detection using the waveform decay method, the power transmission device 402 adjusts the threshold based on this reference quality factor value to determine the final threshold.

Note that, during the negotiation phase, the reference quality factor value sent from the power receiving device 401 to the power transmission device 402 is originally information used for foreign object detection in the Q-value measurement method which measures the Q-value in the frequency domain. In the meanwhile, if the waveform attenuation index is designated as the Q-value, although the method of deriving the Q-value is different, even with the waveform decay method which measures the Q-value in the time domain, it is possible to obtain the Q-value, for example, from the waveform illustrated in FIG. 6 using equation (1) described above. Therefore, it is possible to set the threshold for the Q-value in the waveform decay method based on the reference quality factor value. In this way, based on information that has already been sent in the negotiation phase from the power receiving device 401 to the power transmission device 402, the power transmission device 402 sets the threshold for the Q-value in the waveform decay method, thereby eliminating the need for a new measurement or the like for the threshold setting. This makes it possible to set the threshold in a shorter time.

The Q-value measured by the power transmission device 402 is compared with the threshold determined by the aforementioned method, and if the measured Q-value is less than the threshold, it is determined that there is a foreign object or there is a possibility of the presence of a foreign object. In contrast, if the measured Q-value is greater than or approximately equal to the threshold, it is determined that there is no foreign object or the possibility of the presence of a foreign object is low. As mentioned earlier, by using the second method, foreign object detection using the waveform decay method can be performed.

The third is a method in which the measurement unit 303 of the power transmission device 402 measures the waveform attenuation index in the absence of a foreign object, and, based on information about the measurement result, the setting unit 304 of the power transmission device 402 adjusts the threshold to determine the final threshold. The value of the waveform attenuation index may differ depending on the transmitted power of the power transmission device 402. This is because the amount of heat generated, various characteristics of the electrical circuits of the power transmission device 402, etc. change depending on the magnitude of the transmitted power of the power transmission device 402, and they affect the value of the waveform attenuation index. Therefore, the power transmission device 402 measures the waveform attenuation index for each transmitted power and adjusts the threshold based on the measurement result to determine the final threshold, which enables foreign object detection with higher accuracy.

FIG. 9 is a diagram for describing a method of setting the threshold pertaining to foreign object detection for each transmitted power of the power transmission device 402 in the waveform decay method. First, in response to transmission of power from the power transmission device 402, the power receiving device 401 applies control to enter a light load state in which no power is supplied or only a small amount of power is supplied to the load in the power receiving device 401. Let Pt1 be the transmitted power of the power transmission device 402 at this time. The power transmission device 402 then stops transmitting power in that state and measures the waveform attenuation index. Let 51 be the waveform attenuation index at this time. At this time, the power transmission device 402 recognizes the transmitted power Pt1 being transmitted by the power transmission device 402, and stores a calibration point 900 associating the transmitted power Pt1 with the waveform attenuation index 51 in the memory 106.

Next, the power receiving device 401 controls the load in the power receiving device 401 to enter a load-connected state such that, in response to transmission of power from the power transmission device 402, the maximum power or power greater than or equal to a certain threshold is supplied to the load in the power receiving device 401. Let Pt2 be the transmitted power of the power transmission device 402 at this time. The power transmission device 402 then stops transmitting power in that state and measures the waveform attenuation index. Let 52 be the waveform attenuation index at this time. At this time, the power transmission device 402 stores a calibration point 901 associating the transmitted power Pt2 with the waveform attenuation index 52 in the memory 106.

Then, the power transmission device 402 linearly interpolates between the calibration point 900 and the calibration point 901 to create a straight line 902. The straight line 902 indicates the relationship between the transmitted power and the waveform attenuation index of the transmitted power waveform in the absence of a foreign object in the vicinity of the power transmission device 402 and the power receiving device 401. This makes it possible for the power transmission device 402 to estimate from the straight line 902 the waveform attenuation index of the transmitted power waveform for each transmitted power value in the absence of a foreign object. For example, if the transmitted power value is Pt3, the waveform attenuation index can be estimated to be 53 from a point 903 on the straight line 902 corresponding to the transmitted power value Pt3. Then, based on the above estimation result, the power transmission device 402 can calculate a threshold used for determining the presence or absence of a foreign object for each transmitted power value.

For example, a waveform attenuation index that is only larger, by a value corresponding to a measurement error, than the estimation result of the waveform attenuation index for a given transmitted power value in the absence of a foreign object may be set as a threshold for determining the presence or absence of a foreign object. A calibration process performed by the power transmission device 402 and the power receiving device 401 to enable the power transmission device 402 to obtain a combination of the transmitted power value and the waveform attenuation index is hereinafter referred to as a “waveform attenuation index calibration process (CAL process).” Although two points, namely the transmitted power Pt1 and Pt2, of the power transmission device 402 are measured in the above-described example, measurements may be conducted at three or more points to calculate the waveform attenuation index for each transmitted power in order to enhance the accuracy.

Note that the power receiving device 401 may perform control to ensure that no power is supplied to the load or to enter a light load state, and control to enter a load-connected state, after notifying the power transmission device 402 of the control. Moreover, either of the two types of control may be performed first.

Furthermore, the operations described above for calculating the threshold used for determining the presence or absence of a foreign object for each load (for each transmitted power value) may be performed during the calibration phase. As mentioned earlier, in the calibration phase, the power transmission device 402 obtains data required when performing foreign object detection using the power loss method. At that time, the power transmission device 402 obtains data related to power loss in the cases where the load state of the power receiving device 401 is a light load state and in the case of a load-connected state.

Therefore, it is acceptable to conduct measurements of the calibration point 900 and the calibration point 901 in FIG. 9 together with the aforementioned measurement of power loss. In this case, the power transmission device 402, upon receiving the first reference received power information from the power receiving device 401, conducts a measurement of the calibration point 900 in addition to the processing to be performed in the aforementioned calibration phase.

Also, the power transmission device 402, upon receiving the second reference received power information from the power receiving device 401, conducts a measurement of the calibration point 901 in addition to the processing to be performed in the aforementioned calibration phase. This eliminates the need to separately provide a period for conducting measurements of the calibration point 900 and the calibration point 901, so that measurements of the calibration point 900 and the calibration point 901 can be conducted in a shorter time.

Thus, based on information about the waveform attenuation index measured by the power transmission device 402 at each transmitted power, the power transmission device 402 adjusts and sets the threshold for the waveform attenuation index in the waveform decay method of each transmitted power. For example, if the waveform attenuation index is designated as the Q-value, the Q-value measured by the power transmission device 402 is compared with the threshold determined by the aforementioned method, and, if the measured Q-value is less than the threshold, it is determined that there is a foreign object or there is a possibility of the presence of a foreign object. In contrast, if the measured Q-value is greater than or approximately equal to the threshold, it is determined that there is no foreign object or the possibility of the presence of a foreign object is low. In this way, it is possible to set a threshold at each transmitted power of the power transmission device 402, which enables foreign object detection with higher accuracy.

### Processing of Power Receiving Device 401 and Power Transmission Device 402

The flow of processing of the power receiving device 401 and the power transmission device 402 for performing the above-described contents will be described with reference to the flowcharts for the power receiving device 401 in FIGS. 10A and 10B and the flowcharts for the power transmission device 402 in FIGS. 11A and 11B. These flowcharts relate to processing of exchanging capability information related to the transmission power control period during the aforementioned negotiation phase, and processing when requesting foreign object detection using the waveform decay method using various RPs.

FIG. 10A is a flowchart illustrating an example of the processing procedure of the power receiving device 401 during the negotiation phase.

First, at S1001, the control unit 201 of the power receiving device 401 sends a transmission power control minimum period request command to the power transmission device 402. Then, at S1002, the control unit 201 waits until it receives a response from the power transmission device 402. Here, the reception of a response in the power receiving device 401 may be realized by the control unit 201 polling the communication unit 204, or it may be a method in which the communication unit 204 raises interrupts to the control unit 201. In addition, the received response is transferred to and retained in the memory 208. The command transmission process in the power receiving device 401 can be realized by the control unit 201 sending a request command through the communication unit 204.

Upon receiving a response from the power transmission device 402, at S1003, the control unit 201 verifies information, included in the response, about the transmission power control minimum period that can be generated by the power transmission device 402. Then, at S1004, the control unit 201 compares the obtained transmission power control minimum period with the transmission power control maximum period that the power receiving device 401 can accommodate.

Here, there are several methods of setting the transmission power control maximum period that the power receiving device 401 can accommodate. The transmission power control maximum period, as mentioned earlier, refers to the maximum value of the transmission power control period that is allowed for the power receiving device 401. This maximum value is a value that indicates the period within which transmission is not considered to have been stopped when power transmission is temporarily stopped due to foreign object detection using the waveform decay method, and it can vary depending on various conditions of the power receiving device 401.

As a first method, a method of setting a predetermined fixed value is considered as a method of setting the transmission power control maximum period that the power receiving device 401 can accommodate. It is also acceptable to set a value predetermined from the specifications of modules related to power reception, such as the power receiving unit 203, the power receiving antenna 205, the second switch unit 210, and the resonant capacitor 211.

As a second method, a value calculated from the operating mode and the degree of dependence of the power receiving device 401 on the received power supply in view of the power consumption may be set as the transmission power control maximum period that the power receiving device 401 can accommodate. For example, in a situation where the battery 207 has been removed and the power receiving device 401 is solely operating on power received through wireless power transmission, an extended period of power transmission interruption would lead to the consumption of power stored in the resonant capacitor 211, leading to power loss. In this situation, when the operating mode of the power receiving device 401 is a high load mode, the duration of loss of power from the resonant capacitor 211 during the power transmission control period is shortened; consequently, the acceptable power transmission control period is also reduced. As mentioned earlier, when the power receiving device 401 exhibits a high dependency on received power, a value as small as possible is selected as the transmission power control maximum period. When the power receiving device 401 exhibits a not-so-high dependency on received power, such as when the battery 207 is installed and there is ample stored power, a large value is selected as the transmission power control maximum period in order to enhance the reliability of foreign object detection using the waveform decay method. As mentioned earlier, it is also possible to set the transmission power control maximum period in view of the operating mode and the degree of dependence of the power receiving device 401 on the received power supply in view of the power consumption.

Next, at S1005, the control unit 201 determines whether the transmission power control maximum period that the power receiving device 401 can accommodate satisfies the condition of being greater than or equal to the transmission power control minimum period that can be generated by the power transmission device 402. If, as a result of this determination, the condition of being greater than or equal to the transmission power control minimum period that can be generated by the power transmission device 402 is satisfied, the procedure moves to S1007. In contrast, if the condition of being greater than or equal to the transmission power control minimum period that can be generated by the power transmission device 402 is not satisfied, the procedure moves to S1006. At S1006, the control unit 201 enables a flag indicating not to implement foreign object detection using the waveform decay method. This action can be realized by the control unit 201 retaining information about the flag in a certain area of the memory 208.

Next, at S1007, the control unit 201 sends a transmission power control maximum period notification command to the power transmission device 402. Then, at S1008, the control unit 201 waits until it receives a response from the power transmission device 402. Note that the method of realizing these actions is the same as S1001 and S1002.

Upon receiving a response from the power transmission device 402, at S1009, the control unit 201 sends to the power transmission device 402 other commands required in the negotiation phase. Here, the commands required in the negotiation phase include commands pertaining to the GP requested by the power receiving device 401, as well as commands necessary for executing the foreign object detection processing using the Q-value measurement method. Then, at S1010, the control unit 201 waits until it receives a response to the sent command.

Upon receiving a response from the power transmission device 402, at S1011, the control unit 201 determines whether the command sent at S1009 is a command to report the end of the negotiation phase. If, as a result of this determination, the command is a command that reports the end of the negotiation phase, the flowchart ends. In contrast, if not, the procedure returns to S1009, where the control unit 201 sends the next command required in the negotiation phase.

FIG. 11A is a flowchart illustrating an example of the processing procedure of the power transmission device 402 during the negotiation phase.

First, at S1101, the control unit 101 of the power transmission device 402 waits until it receives a command from the power receiving device 401. The reception of a command in the power transmission device 402 may be realized by the control unit 101 polling the communication unit 104, or it may be a method in which the communication unit 104 raises interrupts to the control unit 101. The received response is also transferred to and retained in the memory 106.

Upon receiving a command from the power receiving device 401, at S1102, the control unit 101 determines whether the received command is a transmission power control minimum period request command. If, as a result of this determination, the received command is a transmission power control minimum period request command, the procedure moves to S1103.

At S1103, the transmission power control minimum period that can be generated by the power transmission device 402 is set, and a response including information thereof is generated. In this action, the control unit 101 interprets the command retained in the memory 106 and generates a corresponding response in the memory 106. The transmission power control minimum period set here may be a fixed value as the power transmission device 402, and it may be determined in view of the method of determining the transmission power control period, as mentioned earlier. For example, based on the relationship between the transmitted power from the power transmission device 402 and the transmission power control period, the transmission power control minimum period that can be generated by the power transmission device 402 may be set.

In contrast, if, as a result of the determination at S1102, the received command is not a transmission power control minimum period request command, at S1106, the control unit 101 determines whether the received command is a transmission power control maximum period notification command. If, as a result of this determination, the received command is a transmission power control maximum period notification command, the procedure moves to S1107.

At S1107, the control unit 101 obtains the transmission power control maximum period from the received command and retains information thereof in the memory 106. Then, at S1108, the control unit 101 generates a response to the transmission power control maximum period notification command.

In contrast, if, as a result of the determination at S1106, the received command is not a transmission power control maximum period notification command, at S1109, the control unit 101 performs processing in accordance with the received command. For example, if the received command is a command pertaining to GP, the control unit 101 determines the value of GP based on the value of GP requested by the power receiving device 401, the power transmission capability of the power transmission device 402, and the like. If the received command is an FOD status packet in which information about a reference quality factor value is stored, the control unit 101 adjusts the threshold in the Q-value measurement method to determine the final threshold. Then, at S1110, the control unit 101 generates a response to the received command.

At 51104, the control unit 101 sends the generated response to the power receiving device 401. Then, at 51105, the control unit 101 determines whether the command received at S1101 is a command that reports the end of the negotiation phase. If, as a result of this determination, the command is a command that reports the end of the negotiation phase, the flowchart ends; and if not, the procedure returns to S1101.

Next, based on the result of the aforementioned negotiation phase, the processing of requesting foreign object detection using the waveform decay method using various received power packets will be described. The power receiving device 401 requests foreign object detection using the waveform decay method by providing information about the transmission power control period as arguments in various RP packets (RP0, RP1, and RP2). That is, foreign object detection using the waveform decay method can be performed in the calibration phase or the power transfer phase where RP packets can be sent.

FIG. 10B is a flowchart illustrating an example of the processing procedure related to foreign object detection using the waveform decay method in the power receiving device 401.

First, at S1012, the control unit 201 of the power receiving device 401 checks the information retained in the memory 208 to verify whether the flag indicating not to implement foreign object detection using the waveform decay method is enabled or not. In the case where the action at S1006 mentioned earlier has been executed, the flag indicating not to implement foreign object detection using the waveform decay method has been enabled. If, as a result of this verification, the flag is enabled, the procedure moves to S1013, and if the flag is disabled, the procedure moves to S1014.

At S1013, the control unit 201 sets zero to the transmission power control period to be set in RP packets. This indicates that foreign object detection using the waveform decay method will not be performed. In contrast, at S1014, the control unit 101 sets a value selected from an available transmission power control period as the transmission power control period, and retains that value in the memory 208.

The available transmission power control period here refers to, as mentioned earlier, any value within the range from the transmission power control minimum period that can be generated by the power transmission device 402 to the transmission power control maximum period that the power receiving device 401 can accommodate. Note that there are several methods available for selecting the transmission power control period.

As a first method, there is a method of uniformly determining the maximum value, minimum value, median, etc. within the obtained selection range according to predetermined rules. As a second method, a value calculated from the operating mode and the degree of dependence of the power receiving device 401 on reception power in view of the power consumption may be selected. As mentioned earlier, in a situation where the battery 207 has been removed and the power receiving device 401 is solely operating on power received through wireless power transmission, a value as low as possible is selected as the transmission power control maximum period, and consequently the acceptable power transmission control period is reduced. As mentioned above, when the power receiving device 401 exhibits a high dependency on received power, a value as small as possible is selected.

Furthermore, when the power receiving device 401 exhibits a-not-so high dependency on received power, such as when the battery 207 is installed and there is ample stored power, in order to select a large value as the transmission power control maximum period, a large value can be selected as the transmission power control period as well. As mentioned above, it is also possible to select the transmission power control period in view of the operating mode and the degree of dependence of the power receiving device 401 on the received power supply in view of the power consumption.

Next, at S1015, the control unit 201 generates an RP packet with information about the transmission power control period determined at S1013 or S1014 as an argument and sends it to the power transmission device 402. Then, at S1016, the control unit 201 waits until it receives an ACK response from the power transmission device 402. Then, if no ACK response has been received after waiting for a certain period of time, the procedure returns to S1015 to resend the RP packet. Note that, upon receiving a no decision (ND) response, which will be described later, from the power transmission device 402, the procedure similarly returns to S1015 to resend the RP packet.

If an ACK response has been received from the power transmission device 402, at S1017, the control unit 201 performs the reception processing of foreign object detection result notification. Then, at S1018, the control unit 201 determines, as a result of the received foreign object detection result notification, the presence of a foreign object or whether the probability of the presence of a foreign object is high. If, as a result of this determination, there is a foreign object or the possibility of the presence of a foreign object is high, the procedure proceeds to S1019, and if not, the flowchart ends.

At S1019, the control unit 201 performs certain processing associated with the presence of a foreign object, and ends the flowchart. Here, examples of the certain processing associated with the presence of a foreign object include warning the user and stopping wireless power transmission.

FIG. 11B is a flowchart illustrating an example of the processing procedure related to foreign object detection using the waveform decay method in the power transmission device 402.

First, at S1111, the control unit 101 of the power transmission device 402 checks whether the received RP packet includes information about the transmission power control period. If, as a result of this checking, the RP packet does not include information about the transmission power control period, foreign object detection using the waveform decay method is not requested, so the procedure transitions to S1117, which will be described later. In contrast, if the RP packet includes information about the transmission power control period, the procedure moves to S1112.

Next, at S1112, the control unit 101 checks whether the transmission power control period in the received RP packet is zero. If, as a result of this checking, the transmission power control period is zero, it similarly indicates that no foreign object detection using the waveform decay method will be performed, so the procedure transitions to S1117 described later. In contrast, if the transmission power control period is not zero, the procedure moves to S1113.

Next, at S1113, the control unit 101 (power transmission control unit 302) starts cessation of power transmission for foreign object detection using the waveform decay method according to the obtained information about the transmission power control period. Then, at S1114, the control unit 101 (foreign object detection unit 305) executes foreign object detection using the waveform decay method described above.

Then, at S1115, the control unit 101 determines whether the probability of the presence of a foreign object has been determined. Here, there are several methods of determining the probability of the presence of a foreign object. For example, in the case where the power transmission unit 103 has the function of calculating the probability of the presence of a foreign object based on the result of foreign object detection using the waveform decay method, the probability of the presence of a foreign object can be grasped by the control unit 101 through acquisition of the information. If the power transmission unit 103 has no such function, foreign object detection using the waveform decay method may be repeated several times, and the probability of the presence of a foreign object may be calculated from the statistical results thereof. In this case, the results of foreign object detection using the waveform decay method can be accumulated in the memory 106 and statistically analyzed by the control unit 101 to realize the foregoing function. Note that, if the number of repetitions of foreign object detection using the waveform decay method is small, the probability of the presence of a foreign object is not determined, so it is necessary to have the power receiving device 401 resend the RP packet every time foreign object detection using the waveform decay method is performed.

If, as a result of the determination at S1115, the probability of the presence of a foreign object has not been determined, at S1116, the control unit 101 sends a no decision (ND) as a response to the power receiving device 401 in order to have the power receiving device 401 resend the RP packet. Then, the procedure returns to S1111 to wait for resending of the RP packet. In contrast, if the probability of the presence of a foreign object has been determined, the procedure moves to S1117.

At S1117, the control unit 101 executes processing of the corresponding RP packet. Then, at S1118, the control unit 101 sends an ACK as a response to the power receiving device 401. Then, at S1119, the control unit 101 determines whether foreign object detection using the waveform decay method has been performed at S1114. If, as a result of this determination, foreign object detection using the waveform decay method has not been implemented, the flowchart ends. In contrast, if foreign object detection using the waveform decay method has been implemented, at S1120, the control unit 101 sends a foreign object detection result notification including information about the presence probability of a foreign object to the power receiving device 401, and ends the flowchart.

According to the present embodiment as described above, in accordance with the result of the negotiation phase, in the case of the condition indicating that foreign object detection using the waveform decay method cannot be performed, information about the transmission power control period in the RP packets is set to zero. This makes it possible to disable foreign object detection using the waveform decay method. In this way, in the present embodiment, a mechanism that can reliably perform foreign object detection can be realized only when both conditions for foreign object detection using the waveform decay method of the power transmission device 402 and the power receiving device 401 are appropriately satisfied.

### Second Embodiment

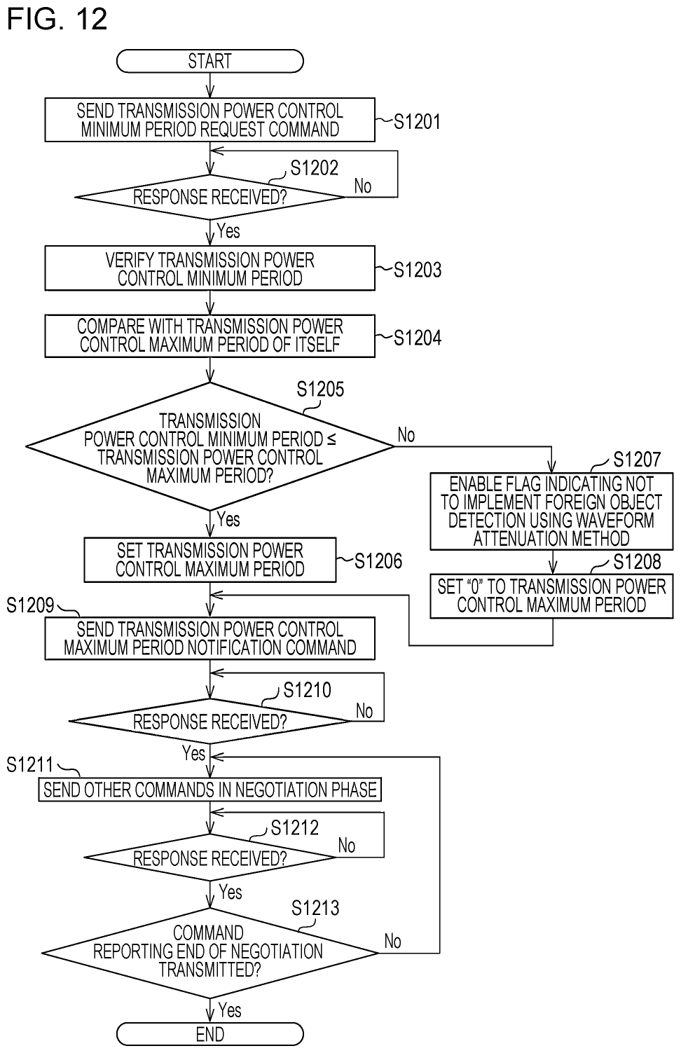

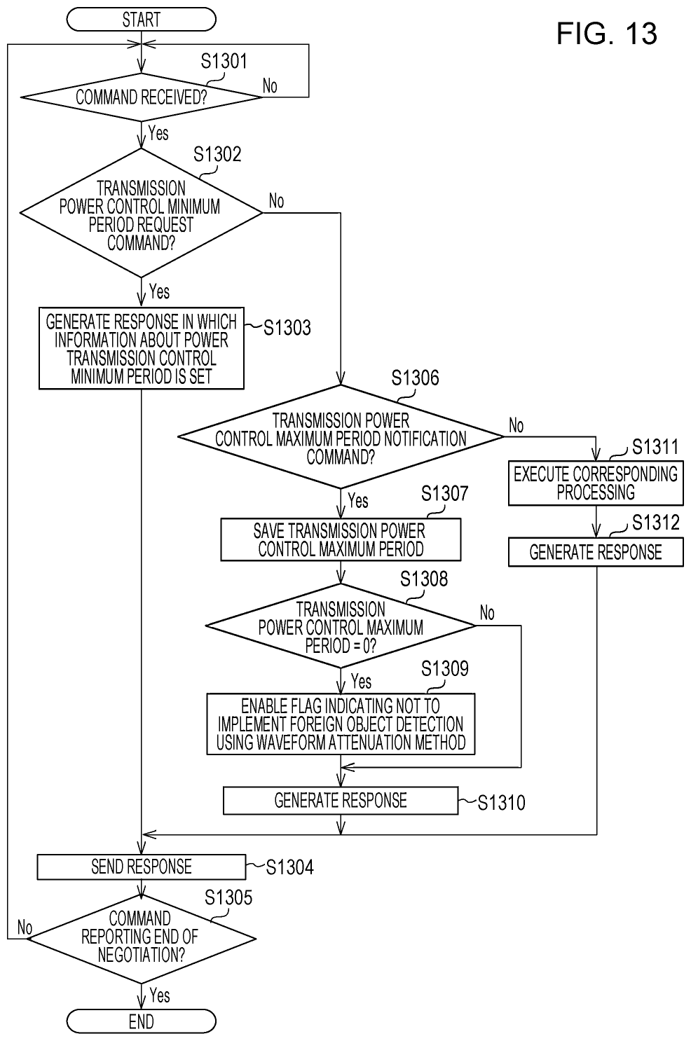

In the first embodiment, the application method in the case of performing foreign object detection using the waveform decay method in accordance with the WPC standards, the method of setting each period of the transmitted power waveform in the case where the waveform decay method is used, and the method of setting a foreign object detection threshold in the waveform decay method have been described. In addition, through the exchange of capability information in the transmission power control period of both the power transmission device 402 and the power receiving device 401 during the negotiation phase, the processing procedure of the power receiving device 401 in the case where it is not possible to perform foreign object detection using the waveform decay method has been described. A second embodiment will describe an example of establishing a common understanding during the negotiation phase in the case where it is not possible to implement foreign object detection using the waveform decay method as a result of the exchange of capability information in the transmission power control period during the negotiation phase. Note that the internal configuration of the power receiving device 401 and the power transmission device 402 is the same as that in the first embodiment, and only differences from the first embodiment, including processing procedures, will be described. Hereinafter, with reference to FIGS. 12 and 13, the processing procedure will be described of establishing a common understanding, between both the power transmission device 402 and the power receiving device 401, that foreign object detection using the waveform decay method will not be implemented.

FIGS. 12 and 13 are flowcharts illustrating examples of the processing procedures during the negotiation phase, performed by the power receiving device 401 and the power transmission device 402, respectively. Note that, due to the significant overlap with the flowcharts of FIGS. 10A and 11B, explanations of the overlapping portions in FIGS. 12 and 13 are omitted.

First, the processing procedure in the power receiving device 401 will be described. In the flowchart illustrated in FIG. 12, S1201 to S1205 of FIG. 12 are the same as S1001 to S1005 of FIG. 10A, respectively, and S1207 of FIG. 12 is the same as S1006 of FIG. 10A. Furthermore, S1209 to S1213 of FIG. 12 are also the same as S1007 to S1011 of FIG. 10A, respectively.

If, as a result of the determination at S1205, the transmission power control maximum period that the power receiving device 401 can accommodate satisfies the condition of being greater than or equal to the transmission power control minimum period that can be generated by the power transmission device 402, the procedure moves to S1206. Then, at S1206, the control unit 201 sets information about the transmission power control period to be reported next in S1209.

In contrast, if a flag indicating not to implement foreign object detection using the waveform decay method is enabled at S1207, the procedure moves to S1208. At S1208, the control unit 201 sets zero to the transmission power control period of the power receiving device 401. Then, next at S1209, the fact that the transmission power control maximum period is zero is included in a transmission power control maximum period notification command. This results in the power receiving device 401 notifying the power transmission device 402 that it does not request the implementation of foreign object detection using the waveform decay method.

Next, the processing procedure in the power transmission device 402 will be described. In the flowchart illustrated in FIG. 13, S1301 to S1307 of FIG. 13 are the same as S1101 to S1107 of FIG. 11A, respectively. Also, S1310 to S1312 in FIG. 13 are the same as S1108 to S1110 in FIG. 11A, respectively.

At S1307, once the information about the transmission power control maximum period that the power receiving device 401 can accommodate is retained in the memory 106, the procedure moves to S1308. At S1308, the control unit 101 determines whether the value of the transmission power control maximum period retained in the memory 106 is zero. If, as a result of this determination, the value of the transmission power control maximum period is not zero, the procedure moves to S1310, and if the value of the transmission power control maximum period is zero, the procedure moves to S1309. Then, at S1309, the control unit 101 sets a flag indicating not to implement, as the power transmission device 402, foreign object detection using the waveform decay method, and retains the flag information in a certain area in the memory 106. This makes it possible for the power transmission device 402 too to reliably grasp that foreign object detection using the waveform decay method will not be implemented.

According to the present embodiment as described above, during the negotiation phase, if both the power transmission device 402 and the power receiving device 401 are under the condition that they are unable to perform foreign object detection using the waveform decay method, information indicative thereof can be shared between the power transmission device 402 and the power receiving device 401. By doing so, it becomes effective as a measure to address unforeseen situations that may occur in subsequent phases. As an unforeseen situation, for example, the case is assumed in which the power receiving device 401 has requested foreign object detection using the waveform decay method with the RP packet, despite the situation in which it is not possible to implement foreign object detection using the waveform decay method. Due to a software defect or the like in the power receiving device 401, it may occur that the RP packet is sent despite the condition in the first place that foreign object detection using the waveform decay method is not executable. In this case, since the power transmission device 402 can verify the flag indicating not to implement foreign object detection using the waveform decay method, the unintended implementation of foreign object detection using the waveform decay method can be avoided. This makes it possible to avoid a situation where, as a result of implementing foreign object detection using the waveform decay method according to the received RP packet, power loss occurs in the power receiving device 401.

### Third Embodiment

In the first and second embodiments described above, the procedures have been described in which, by setting a flag indicating not to implement foreign object detection using the waveform decay method, the implementation of unintended foreign object detection using the waveform decay method is prevented. A third embodiment will describe the handling of the once-set flag indicating not to implement foreign object detection using the waveform decay method. Note that the internal configuration of the power receiving device 401 and the power transmission device 402 is the same as that in the first embodiment, and only differences from the first embodiment, including the processing procedures, will be described.

First, in the case where a flag indicating not to implement foreign object detection using the waveform decay method has been set, a method of resetting the flag will be described. In the first embodiment, the method in which, when the power receiving device 401 determines information pertaining to the transmission power control period at S1014, the information is selected in view of the operating mode and the degree of dependence on reception power supply based on the power consumption has been described. As mentioned earlier, if the transmission power control period is determined in accordance with the operating state of the power receiving device 401, there may be a situation where, due to a change in the operating state of the power receiving device 401, it becomes acceptable to change the flag indicating not to implement foreign object detection using the waveform decay method.

Accordingly, in the present embodiment, upon detecting a change in the operating state of the power receiving device 401, the procedure illustrated in FIG. 10A or FIG. 12 is redone to reset the flag indicating not to implement foreign object detection using the waveform decay method in accordance with the new operating state. Here, possible changes in the operating state include cases in which the detachable battery, which had been removed, has been installed, the operating mode transitions to a power-saving mode, or conversely, transitions to a high-load mode.

In addition, in wireless power transmission compliant with the WPC standards, the flag indicating not to implement foreign object detection using the waveform decay method may be reset at a time point at which the operating mode transitions to a selection mode. When the operating mode transitions to the selection mode, the state transition is reset; therefore, in accordance with this reset, it is conceivable to additionally reset the flag indicating not to implement foreign object detection using the waveform decay method.

Furthermore, conditions may be set to maintain the setting of the flag indicating not to implement foreign object detection using the waveform decay method. Assuming wireless power transmission compliant with the WPC standards, there may be situations where power can be transmitted wirelessly from the same power transmission device, such as re-ping or restart. In such cases, it can be determined that there is no change in the power transmission device and the relationship with the power transmission device is maintained; therefore, it is acceptable to maintain the setting of the flag indicating not to implement foreign object detection using the waveform decay method.

### Other Embodiments

The first to third embodiments described above may be suitably combined. In addition, in the above-described embodiments, the power transmission device 402 performs transmission power control and performs foreign object detection based on the waveform attenuation index. Another method to measure the Q-value, which is one of the waveform attenuation indices, involves transmitting a signal (such as a pulse wave) with multiple frequency components, measuring the amplitude or decay state of the waveform of the signal, and performing computational processing (such as Fourier transform) on the result. Accordingly, this method can also be applied to the first to third embodiments described above.

Furthermore, although foreign object detection using the waveform decay method is disabled in the case where the transmission power control minimum period is longer than the transmission power control maximum period in the first to third embodiments described above, the determination criterion is not limited to this condition. For example, in the case where the transmission power control maximum period is slightly longer than the transmission power control minimum period, the accuracy of foreign object detection may decrease within the range of period errors, or there may be cases where the cessation of power transmission is mistakenly determined, which means that measurement errors are likely to occur. Therefore, even when the transmission power control minimum period is shorter than the transmission power control maximum period, if the difference is less than or equal to a certain value, it may be deemed that it is impossible to set the transmission power control period, and foreign object detection using the waveform decay method may be disabled.

The present disclosure can also be realized by supplying a program that realizes one or more functions of the aforementioned embodiments to a system or device via a network or storage medium, and executing the program by one or more processors in the computer of the system or device. The disclosure can also be realized by a circuit (e.g., application specific integrated circuit (ASIC)) that realizes one or more functions.

At least a portion of the processing illustrated in the flowcharts of FIGS. 10A to 13 may be implemented using hardware. In the case of realizing a portion of the processing using hardware, for example, a certain compiler is used to automatically generate dedicated circuits on a field-programmable gate array (FPGA) from a program for realizing each step. Alternatively, a gate array circuit may be formed in the same manner as an FPGA and realized as hardware.

According to the present disclosure, in foreign object detection based on waveform attenuation, appropriate control can be performed when the situation becomes unsuitable for foreign object detection.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A power receiving device comprising:
a receiving unit configured to receive power wirelessly from a power transmission device;
an obtaining unit configured to obtain, from the power transmission device, information on a first period in which the power transmission device limits power transfer; and
a transmission unit configured to transmit, based on the obtained information, to the power transmission device information disabling foreign object detection based on a decay.

2. The power receiving device according to claim 1, further comprising:
a setting unit configured to set, based on the obtained information, a period in which the power transmission device limits power transfer.

3. The power receiving device according to claim 2, further comprising:
a comparison unit configured to compare the first period with a second period allowed for the power receiving device.

4. The power receiving device according to claim 3, wherein the transmission unit is configured to transmit, based on a result of a comparison by the comparison unit, the information disabling the foreign object detection.

5. The power receiving device according to claim 3, wherein the transmission unit is configured to transmit the information disabling the foreign object detection, in a case where a period in which the power transmission device limits power transfer is not set.

6. The power receiving device according to claim 3, wherein the transmission unit is configured to transmit the information disabling the foreign object detection in a case where the first period is longer than the second period.

7. The power receiving device according to claim 1, wherein, in a case of requesting the power transmission device the foreign object detection, the transmission unit is configured to transmit the information disabling the foreign object.

8. The power receiving device according to claim 1, wherein the transmission unit is configured to transmit information on a period in which the power transmission device limits power transfer set to zero as the information disabling the foreign object detection.

9. The power receiving device according to claim 3, wherein the transmission unit is configured to transmit to the power transmission device information indicating that a period in which the power transmission device limits power transfer is zero, with information about the second period.

10. The power receiving device according to claim 3, wherein:
the second period is a value that changes.

11. The power receiving device according to claim 10, wherein the second period changes according to attachment/detachment of a battery.

12. The power receiving device according to claim 10, wherein the second period changes according to a transition between a power saving mode and a high load mode.

13. A method for a power receiving device, the method comprising:
receiving power wirelessly from a power transmission device;
obtaining, from the power transmission device, information on a first period in which the power transmission device limits power transfer; and
a transmission unit configured to transmit, based on the obtained information, to the power transmission device information disabling foreign object detection based on a decay.

14. A computer-readable storage medium storing a program for executing a method a power receiving device, the method comprising:
receiving power wirelessly from a power transmission device; and
obtaining, from the power transmission device, information on a first period in which the power transmission device limits power transfer; and
a transmission unit configured to transmit, based on the obtained information, to the power transmission device information disabling foreign object detection based on a decay.
